(19) United States
(12) Patent Application Publication
(10) Pub. No.: US 2026/0230261 A1
(43) Pub. Date: Aug. 6, 2026

(54) WTRU-ORIENTED DIRECT CLI MEASUREMENT INITIATION AND HANDLING

(71) Applicant: InterDigital Patent Holdings, Inc., Wilmington, DE (US)

(72) Inventors: Jonghyun Park, Syosset, NY (US); Moon IL Lee, Melville, NY (US); Tao Deng, New York, NY (US); Aata El Hamss, Laval (CA); Nazli Khan Beigi, Longueuil (CA); Virgile Garcia, Antibes (FR)

(73) Assignee: InterDigital Patent Holdings, Inc., Wilmington, DE (US)

(21) Appl. No.: 19/044,272

(22) Filed: Feb. 3, 2025

(51) Int. Cl. H04L 5/00; H04B 17/309; H04B 17/318; H04W 24/08

(52) U.S. Cl. CPC H04L 5/0051; H04B 17/328; H04B 17/346; H04W 24/08

(57) ABSTRACT

In some implementations, a method may include receiving configuration information including a first set of resources for RS transmission and a first mapping between a CLI indication and a corresponding RS resource from the first set of resources. The method may include transmitting an UL signal, and monitoring a second set of resources for a CLI indication. The method may include triggering a CLI management action for RS transmission based on a format of the CLI indication and/or a type of signal to monitor for the CLI indication. The method may include determining a resource for the RS transmission based on the first mapping and one or more RS transmission parameters. The method may include sending the RS transmission according to the one or more RS transmission parameters including the determined resource.

### BACKGROUND

Development work of 5G New Radio (NR) duplex operation is currently underway. This technology may be a great foundation in improving conventional TDD operation by enhancing UL coverage, improving capacity, reducing latency, and so forth. Conventional TDD is based on splitting the time domain between the uplink and downlink. In 3GPP NR Rel-19, the feasibility of allowing full duplex, or more specifically, sub-band non-overlapping full duplex (SBFD) at the gNB within a conventional TDD band is investigated, where an UL sub-band may be configured within a DL slot/symbol.

In future 5G releases or in 6G, the technology may evolve to include more flexible, dynamic duplexing, for example, dynamic SBFD, in-band/overlapping full duplex, etc. where cross-link interferences (CLI) may become a more common interference issue. The realization of SBFD (or more advanced duplexing schemes) is subject to resolving the key challenges raised due to CLI. The CLI can be measured at both the victim and/or aggressor UEs, for example, using reciprocity. For UEs, the UL-to-DL CLI happens when an UL transmission from an aggressor UEs causes interferences at a victim UEs receiving DL transmissions, for example different types of UL-to-DL CLI. Currently, CLI management and identification is network-controlled, for example, SRS transmissions and measurements are aligned through network (periodic, semi-persistent or aperiodic configuration possible). Network controlled CLI identification can be slow and require several configuration alignments from network to UEs, measurements triggers, and reports (with multiple trials and error) to identify the CLI source. When an inter-UE CLI happens, for example, on a DL transmission, a UE doesn't have a way to report the CLI directly or a procedure to identify the CLI source. Thus, the need exists for a technological solution for aggressor UE's to monitor for CLI and for victim UE's to identify a source of CLI.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include receiving, from a network, configuration information including a first set of resources for reference signal (RS) transmission and a first mapping between a cross-link interference (CLI) indication and a corresponding RS resource from the first set of resources. The method may also include transmitting an uplink (UL) signal. The method may furthermore include monitoring a second set of resources to for a CLI indication based on at least one of: a format of the CLI indication, or a type of signal to monitor for the CLI indication. The method may include triggering a CLI management action for RS transmission based on at least one of: a format of the CLI indication, or a type of signal to monitor for the CLI indication. The method may also include determining a resource for the RS transmission based on the first mapping between the CLI indication and the corresponding RS resource, and one or more RS transmission parameters. The method may furthermore include sending the RS transmission according to the one or more RS transmission parameters including the determined resource. Other embodiments of this aspect include corresponding computer systems, apparatus, and computer programs recorded on one or more computer storage devices, each configured to perform the actions of the methods.

Implementations may include one or more of the following features. The method where the RS transmission is at least one of: an UL RS, a sounding reference signal (SRS), an demodulation reference signal (DM-RS), a phase tracking reference signal (PT-RS), a sidelink (SL) synchronization signal block (SSB), a SL-DMRS, or a SL channel state information reference signal (CSI-RS). The method may include: receiving, from the network, a second mapping between one or more UL transmission resources and one or more corresponding resources from the second set of resources, wherein the one or more UL transmission resources are configured by the network; and determining the second set of resources based on the second mapping and one or more UL transmission parameters. The method may include determining to monitor for the CLI indication based on at least one of: transmission parameters of the UL signal transmitted, or a position of the WTRU. The method may include: receiving, from the network, a command to transmit the UL signal, where the command to transmit the UL signal includes an indicator to monitor for the CLI indication on at least one resource from the second set of resources after transmitting the UL signal. The method may include detecting the CLI indication based on a measurement on CLI indication resources being above a configured threshold value, where the measurement on the CLI indication resources includes at least one of: an energy level, a received signal strength indicator (RSSI) measurement, a reference signal received power (RSRP) measurement, or a signal-to-interference-plus-noise ratio (SINR) measurement. The method where the type of signal to monitor for the CLI indication is at least one of: a dedicated sequence, or an existing RS, where the existing RS is at least one of: an UL RS, demodulation reference signal (DM-RS), an UL phase tracking reference signal (PT-RS), a sidelink (SL) SSB, a SL RS, or a SL DM-RS. The method where the one or more RS transmission parameters include at least one of: a transmit power, a transmit beam, or a determined sequence. The method may include determining the RS transmission parameters based on the CLI indication, where the CLI indication includes information indicating at least one of transmit power, or a sequence index. Implementations of the described techniques may include hardware, a method or process, or a computer tangible medium.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates examples of Cross Link Interference (CLI) including inter-gNB and inter-UE CLI;

FIG. 3 illustrates and example of a sub-band non-overlapping full duplex (SBFD) operation;

FIG. 4 illustrates an overview of the interaction between an aggressor WTRU and a victim WTRU;

FIG. 5 illustrates an process of a WTRU triggering SRS transmission based on reception of CLI indication from another WTRU;

FIG. 6 illustrates a WTRU requesting another WTRU for SRS transmission and performing CLI measurement;

FIG. 7 illustrates a WTRU determining the monitoring of the CLI indication and its resource; and

FIG. 8 is a flow diagram of an example CLI management and identification process.

### DETAILED DESCRIPTION

The following acronyms may be referred to in the description that follows:
ACK Acknowledgement
BLER Block Error Rate
BWP Bandwidth Part
CAP Channel Access Priority
CAPC Channel access priority class
CCA Clear Channel Assessment
CCE Control Channel Element
CE Control Element
CG Configured grant or cell group
CP Cyclic Prefix
CP-OFDM Conventional OFDM (relying on cyclic prefix)
CQI Channel Quality Indicator
CRC Cyclic Redundancy Check
CSI Channel State Information
CW Contention Window
CWS Contention Window Size
CO Channel Occupancy
DAI Downlink Assignment Index
DCI Downlink Control Information
DFI Downlink feedback information
DG Dynamic grant
DL Downlink
DM-RS Demodulation Reference Signal
DRB Data Radio Bearer
eLAA enhanced Licensed Assisted Access
FeLAA Further enhanced Licensed Assisted Access
HARQ Hybrid Automatic Repeat Request
LAA License Assisted Access
LBT Listen-Before-Talk
LTE Long Term Evolution e.g. from 3GPP LTE R8 and up
NACK Negative ACK
MCS Modulation and Coding Scheme
MIMO Multiple Input Multiple Output
NR New Radio
OFDM Orthogonal Frequency-Division Multiplexing
PHY Physical Layer
PID Process ID
PO Paging Occasion
PRACH Physical Random Access Channel
PSS Primary Synchronization Signal
RA Random Access (or procedure)
RACH Random Access Channel
RAR Random Access Response
RCU Radio access network Central Unit
RF Radio Front end
RLF Radio Link Failure
RLM Radio Link Monitoring
RNTI Radio Network Identifier
RO RACH occasion
RRC Radio Resource Control
RRM Radio Resource Management
RS Reference Signal
RSRP Reference Signal Received Power
RSSI Received Signal Strength Indicator
SDU Service Data Unit
SRS Sounding Reference Signal
SS Synchronization Signal
SSS Secondary Synchronization Signal
SWG Switching Gap (in a self-contained subframe)
SPS Semi-persistent scheduling
SUL Supplemental Uplink
TB Transport Block
TBS Transport Block Size
TRP Transmission/Reception Point
TSC Time-sensitive communications
TSN Time-sensitive networking
UL Uplink
URLLC Ultra-Reliable and Low Latency Communications
WBWP Wide Bandwidth Part
WLAN Wireless Local Area Networks and related technologies (IEEE 802.xx domain)

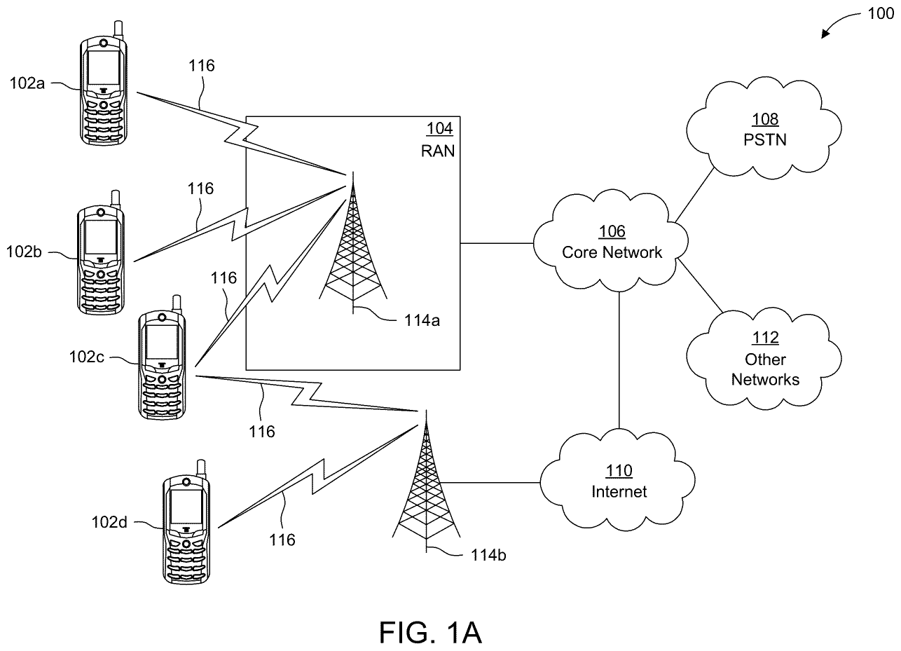

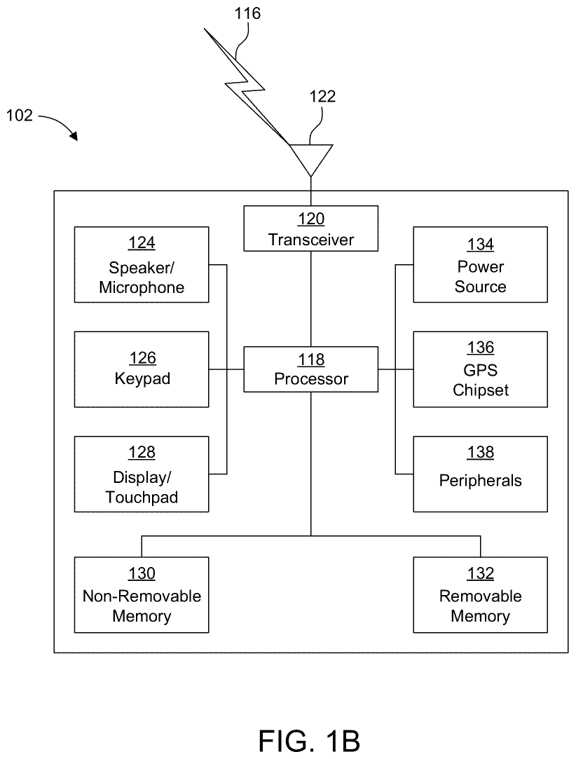

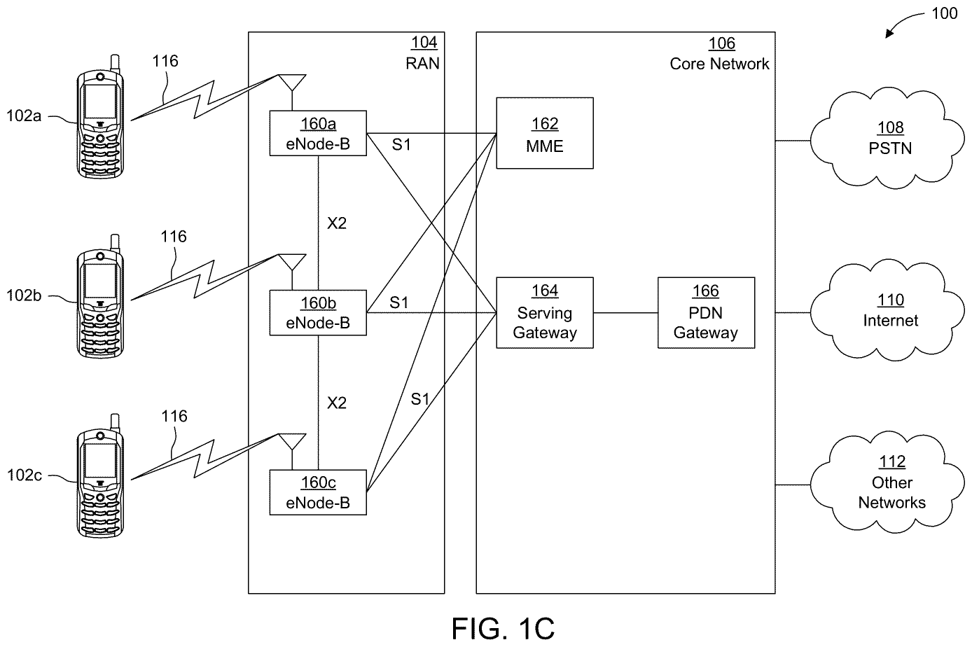

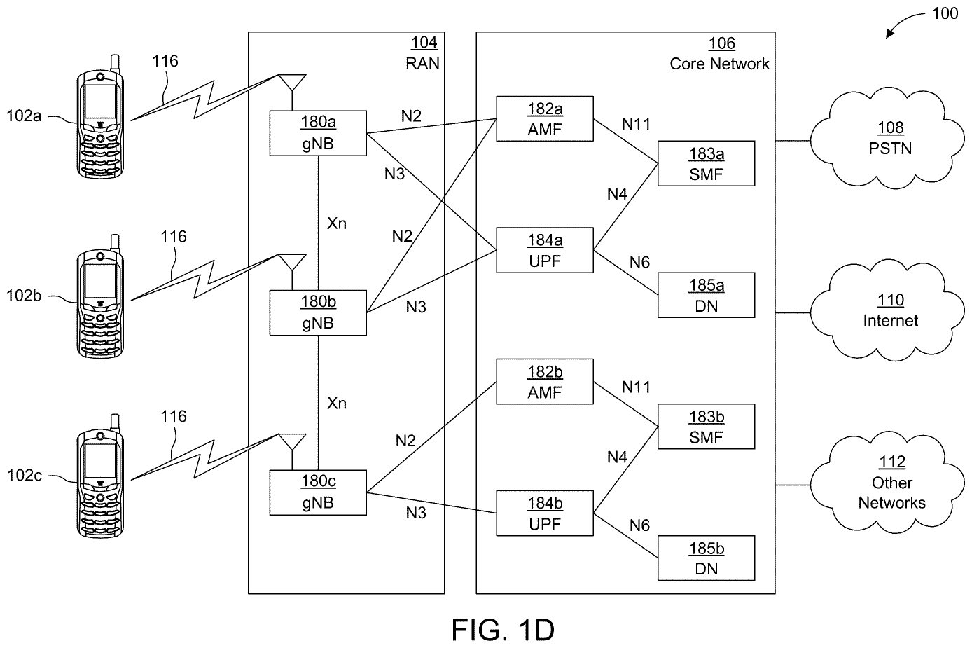

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

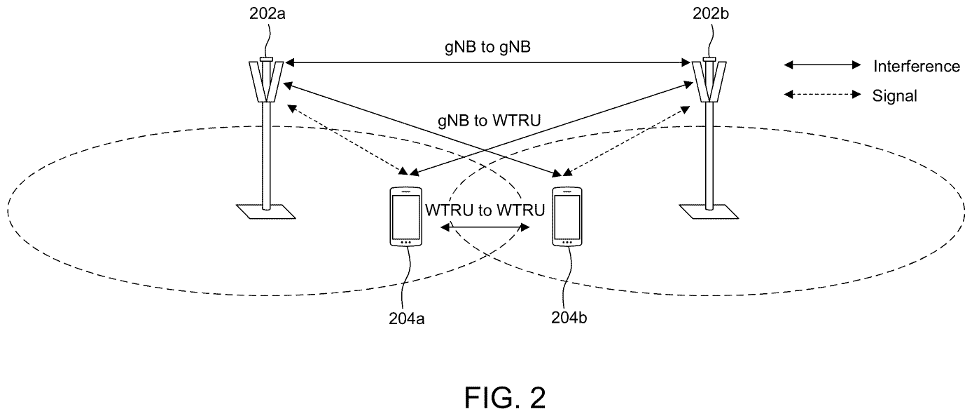

FIG. 2 illustrates examples of Cross Link Interference (CLI) including inter-gNB and inter-UE CLI.

In the example illustrated in FIG. 2, gNB 202a is actively serving WTRU 204a and gNB 202b is actively serving WTRU 202b. The UL/DL communication between gNB 202a and WTRU 204a may experience CLI due to signaling between gNB 202a and WTRU 204b, signaling between gNB 202b and WTRU 204a, and signaling between WTRU 204a and WTRU 204b. Likewise, the UL/DL communication between gNB 202b and WTRU 204b may experience from CLI due to signaling between gNB 202a and WTRU 204b, signaling between gNB 202b and WTRU 204a, and signaling between WTRU 204a and WTRU 204b. Each WTRU may be subject to different types of UL to DL CLI.

Intra-frequency, inter-cell (co-channel) CLI may occur when neighboring cells are configured with different link directions in the same carrier frequency, either for SBFD, dynamic/flexible TDD cases, (overlapping/in-band) Full Duplex, XDD, etc. Intra-frequency, inter-sub-band CLI, where an UL transmission (from the serving cell or a neighboring cell) in a SBFD sub-band creates leakage interference in the adjacent DL sub-band, for the SBFD scenario. Inter-frequency CLI, where the UL transmission in an adjacent frequency carrier (from the serving cell or a neighboring cell) creates leakage in the adjacent DL sub-band, for both SBFD and dynamic/flexible TDD scenarios.

A WTRU (aggressor) may be configured to monitor a CLI indication after an UL transmission. The CLI indication is typically sent from another WTRU and indicates that the other WTRU received significant CLI. Receiving the CLI indication, the WTRU may be triggered to perform associated CLI management actions such as transmitting an SRS for CLI measurement/identification, and to determine the SRS resource using (pre)configured mapping.

A WTRU may receive a (pre)configuration, for example, from the network using RRC, for a set of SRS resources for transmission, e.g., (semi-)periodic resources, and a mapping rule between a CLI indication and a corresponding SRS resource, for example, the time of the SRS resource is the earliest resource after the transmission and a delay/offset, and/or a comb/freq/shift/code dependent on time frequency (TF) resource.

The WTRU many receive a command (e.g., DCI) for UL transmission including an indication to monitor for a CLI indication following the transmission. The indication may, for example, indicate: time/frequency resources of the CLI indication to monitor, or the signal to monitor which may be, for example, a dedicated sequence, an UL RS, a PUCCH/PUSCH. This could be an explicit configuration or a pointer to a (pre)configured CLI indication configuration.

The WTRU may transmit the UL transmission according to a received UL grant, monitor the resources indicated in the grant assignment, and trigger a SRS transmission based on detecting a CLI indication in the monitored resources. This may include, in some options: measuring the energy level on the CLI indication resources and detecting the energy is higher than a configured threshold, for example, based on RSSI levels or measuring the energy or power level of the configured sequence and detecting that the energy/power is beyond a configured threshold, for example, based on RSSI, RSRP, SINR, etc.

The WTRU may determine the SRS resources to use for transmission. This may, for example, be based on the configured mapping between the CLI indication and the SRS resources, and SRS transmission parameter (e.g., transmit power and beam). For example, the transmit power and beam may be the same as the UL transmission initiating the CLI indication monitoring. The WTRU may transmit the SRS using the determined transmission parameters.

This may allow the WTRU to trigger a fast CLI identification procedure without trial and errors measurements and configuration from the network.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example.’ A symbol ‘/’ (e.g., forward slash) may be used herein to represent ‘and/or’, where for example, ‘A/B’may imply ‘A and/or B’.

Hereinafter, the term “sub-band” is used to refer to a frequency-domain resource and may be characterized by at least one of the following: a set of resource blocks (RBs), a set of resource block sets (RB sets), e.g. when a carrier has intra-cell guard bands, a set of interlaced resource blocks, a bandwidth part, or portion thereof, and/or a carrier, or portion thereof. For example, a sub-band may be characterized by a starting RB and number of RBs for a set of contiguous RBs within a bandwidth part. A sub-band may also be defined by the value of a frequency-domain resource allocation field and bandwidth part index.

Hereinafter, the term “XDD” is used to refer to a sub-band-wise duplex (e.g., either UL or DL being used per sub-band) and may be characterized by at least one of the following: Cross Division Duplex (e.g., sub-band-wise FDD within a TDD band), sub-band-based full duplex (e.g., full duplex as both UL and DL are used/mixed on a symbol/slot, but either UL or DL being used per sub-band on the symbol/slot), frequency-domain multiplexing (FDM) of DL/UL transmissions within a TDD spectrum, a sub-band non-overlapping full duplex (SBFD) (e.g., non-overlapped sub-band full-duplex), a full duplex other than a same-frequency (e.g., spectrum sharing, sub-band-wise-overlapped) full duplex, or an advanced duplex method, e.g., other than (pure) TDD or FDD.

Hereinafter, the term “dynamic(/flexible) TDD” is used to refer to a TDD system/cell which may dynamically (and/or flexibly) change/adjust/switch a communication direction (e.g., a downlink, an uplink, or a sidelink, etc.) on a time instance (e.g., slot, symbol, subframe, and/or the like). In an example, in a system employing dynamic/flexible TDD, a component carrier(CC) or a bandwidth part (BWP) may have one single type among ‘D’, ‘U’, and ‘F’ on a symbol/slot, based on an indication by a group-common(GC)-DCI (e.g., format 2_0) comprising a slot format indicator (SFI), and/or based on tdd-UL-DL-config-common/dedicated configurations. On a given time instance/slot/symbol, a first gNB (e.g., cell, TRP) employing dynamic/flexible TDD may transmit a downlink signal to a first WTRU being communicated/associated with the first gNB based on a first SFI and/or tdd-UL-DL-config configured/indicated by the first gNB, and a second gNB (e.g., cell, TRP) employing dynamic/flexible TDD may receive an uplink signal transmitted from a second WTRU being communicated/associated with the second gNB based on a second SFI and/or tdd-UL-DL-config configured/indicated by the second gNB. In an example, the first WTRU may determine that the reception of the downlink signal is being interfered by the uplink signal, where the interference caused by the uplink signal may refer to a WTRU-to-WTRU (e.g., UE-to-UE) cross-layer interference (CLI).

Hereinafter, the term “SBFD” is used to refer to a sub-band-wise duplex (e.g., either UL or DL being used per sub-band) and may be characterized by at least one of the following: Cross Division Duplex (e.g., XDD, sub-band-wise FDD within a TDD band), sub-band-based full duplex (e.g., full duplex as both UL and DL are used/mixed on a symbol/slot, but either UL or DL being used per sub-band on the symbol/slot), frequency-domain multiplexing (FDM) of DL/UL transmissions within a TDD spectrum, a sub-band non-overlapping full duplex (SBFD) (e.g., non-overlapped sub-band full-duplex), a full duplex other than a same-frequency (e.g., spectrum sharing, sub-band-wise-overlapped) full duplex, or an advanced duplex method, e.g., other than (pure) TDD or FDD, e.g., partial in-band full duplex, sub-band overlapping full duplex, in-band full duplex(IBFD).

In the following, a property of a grant or assignment may consist of at least one of the following: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); or any parameter provided in a DCI, by MAC or by RRC for the scheduling the grant or assignment.

In the following, an indication by DCI may consist of at least one of the following: an explicit indication by a DCI field or by RNTI used to mask CRC of the PDCCH, or an implicit indication by a property such as DCI format, DCI size, Coreset or search space, or Aggregation Level, first resource element of the received DCI (e.g., index of first Control Channel Element), where the mapping between the property and the value may be signaled by RRC or MAC.

Hereafter, a signal may be interchangeably used with one or more of following: Sounding reference signal (SRS), channel state information—reference signal (CSI-RS), demodulation reference signal (DM-RS), phase tracking reference signal (PT-RS), or synchronization signal block (SSB).

Hereafter, a channel may be interchangeably used with one or more of following: physical downlink control channel (PDCCH), physical downlink shared channel (PDSCH), physical uplink control channel (PUCCH), physical uplink shared channel (PUSCH), physical random access channel (PRACH), and the like, but still consistent with the description.

Hereafter, downlink reception may be used interchangeably with Rx occasion, PDCCH, PDSCH, an SSB reception, but still consistent with the description.

Hereafter, uplink transmission may be used interchangeably with Tx occasion, PUCCH, PUSCH, PRACH, and SRS transmission, but still consistent with the description.

Hereafter, RS may be interchangeably used with one or more of RS resource, RS resource set, RS port and RS port group, but still consistent with the description.

Hereafter, RS may be interchangeably used with one or more of SSB, CSI-RS, SRS, and DM-RS.

Hereafter, time instance may be interchangeably used with slot, symbol, or subframe, but still consistent with the description.

Hereafter, UL-only and DL-only Tx/Rx occasions may interchangeably be used with legacy TDD UL or legacy TDD DL, respectively. In an example, the legacy TDD UL/DL Tx/Rx occasions may be the cases where SBFD is not configured and/or where SBFD is disabled.

Hereafter, a UL signal (e.g., at least one of SRS, DMRS, PUSCH, PUCCH, PRACH, PTRS, etc.) may be used interchangeably with a UL signal or channel, or a UL channel or signal, but still consistent with the description.

Hereafter, a DL signal (e.g., at least one of CSI-RS, SSB, PDSCH, PDCCH, PBCH, PTRS, etc.) may be used interchangeably with a DL signal or channel, or a DL channel or signal, but still consistent with the description.

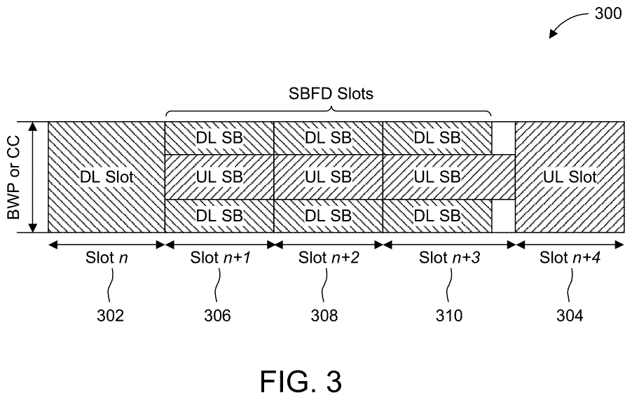

FIG. 3 illustrates and example of an SBFD configuration.

A WTRU may be configured with one or more types of slots within a bandwidth, wherein a first type of slot may be used or determined for a first direction (e.g., downlink, or sidelink (e.g., UE-to-UE communication, device-to-device communication)); a second type of slot may be used or determined for a second direction (e.g., uplink, or sidelink); a third type of slot may have a first group of frequency resources within the bandwidth for a first direction and a second group of frequency resources within the bandwidth for a second direction. Herein, the bandwidth may be interchangeably used with bandwidth part (BWP), carrier, sub-band, and system bandwidth; the first type of slot (e.g., the slot for a first direction) may be referred to as downlink (and/or sidelink) slot; the second type of slot (e.g., slot for a second direction) may be referred to as uplink (and/or sidelink) slot; the third type of slot may be referred to as Sub-Band (non-overlapping or overlapping) Full Duplex (SBFD) slot, e.g., comprising at least one of DL SB(s), UL SB(s), sidelink SB(s), guard band(s) (or RB(s)), and flexible SB(s) (e.g., SB(s) that may be dynamically determined as one of DL SB(s), UL SB(s), sidelink SB(s)); the group of frequency resource for a first direction may be referred to as downlink (and/or sidelink) sub-band, downlink (and/or sidelink) frequency resource, or downlink (and/or sidelink) RBs; the group of frequency resource for a second direction may be referred to as uplink (and/or sidelink) sub-band, uplink (and/or sidelink) frequency resource, or uplink (and/or sidelink) RBs; the group of frequency resource for a flexible direction (e.g., that can be configured for a first direction, second direction, etc.) may be referred to as flexible sub-band, flexible frequency resource, or flexible RBs; and the group of frequency resource between a first direction and a second direction may be referred to as guard band, guard frequency resource, or guard RBs.

As illustrated in FIGS. 3, 302 is a first slot in the downlink direction, and slot 304 is a slot (n+4) in the UL direction. Slots 306-308 are SBFD slots. These slots include a first group of frequency resources within the bandwidth for a first direction and a second group of frequency resources within the bandwidth for a second direction. Slot n+1, 306, includes two groups of frequency resources in the DL direction and a group of frequency resources in a UL direction. Slot n+2, 308, and slot n+3, 310, also include two groups of frequency resources in the DL direction and a group of frequency resources in a UL direction.

In an example, a WTRU may be (pre)configured with one or multiple groups of frequency resources, where some groups of frequency resources are explicitly configured, and some are implicitly configured. For instance, the WTRU may be configured, e.g., within a cell or BWP, with a first group of frequency resources assigned to DL and a second group of resources assigned to UL as shown at 306-310 of FIG. 3. The WTRU may infer that the remaining group(s) of resources are used as guard band. Alternatively, the WTRU may receive a configuration including an UL sub-band and a guard band, and infer that the remaining resources are a DL sub-band, and so forth.

In an example, a (SBFD-enabled) WTRU may receive configuration information or be configured with one or more SBFD UL, DL, sidelink, flexible, and/or guard sub-bands in one or more DL/UL/flexible TDD time instances (e.g., symbols, slots, frames, and so forth). The WTRU may be configured with one or more resource allocations for SBFD sub-bands.

For example, the SBFD configuration may include a flag signal (e.g., enabled/disabled), where for example a first value (e.g., zero (0)) indicates a first mode of operation (e.g., SBFD configuration), and a second value (e.g., one (1)) may indicate a second mode of operation (e.g., non-SBFD operation). The modes of operation (e.g., SBFD and/or non-SBFD) may be indicated via MIB, SIB, RRC, MAC-CE, DCI, and so forth.

The WTRU may receive the time resources (e.g., one or more symbols, slots, and so forth), for which the first mode of operation (e.g., SBFD) is defined in for example one or more BWPs, sub-bands, component carriers (CC), cells, and so forth. The WTRU may receive the frequency resources (e.g., sub-bands/BWPs including one or more PRBs) within (active and/or linked) BWP, for which the first mode of operation (e.g., SBFD) is configured. The time instances (e.g., slots, symbols) may be indicated based on periodic, semi-persistent, or aperiodic type configurations. In an example, the time instances may be indicated via a bitmap configuration, where each bit corresponds to a time instance (e.g., slot, symbol, subframe, etc.) and each bit indication indicates whether corresponding time instance can be used for the first or second mode of operation.

In an example, a WTRU may be configured with a DL TDD configuration for a component carrier (CC) or a BWP for one or more Rx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., sub-bands, PRBs, and/or BWPs) may be configured for the transmission in UL channels and/or Tx occasions.

In another example, the WTRU may be configured with an UL TDD configuration for a component carrier (CC) or a BWP for one or more Tx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., sub-bands, PRBs, and/or BWPs) may be configured as the DL channels and/or Rx occasions.

In yet another example, the WTRU may be configured with a DL, UL, or Flexible TDD configuration for a component carrier (CC) or a BWP for one or more Rx/Tx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., sub-bands, PRBs, and/or BWPs) may be configured for the first mode of operation (e.g., either UL transmission or DL reception based on the configurations).

The duplexing mode for the first mode of operation (e.g., SBFD configuration (UL/DL)) may be indicated via a flag indication, where for example a first value (e.g., zero (0)) may indicate a first direction (e.g., UL duplexing mode), and a second the value (e.g., one (1)) may indicate a second direction (e.g., DL duplexing model).

The duplexing mode configuration and/or flag for the first mode of operation (e.g., SBFD) may be configured as part of modes of operation configuration, for example via MIB, SIB, RRC, DCI, MAC-CE, etc.

The duplexing mode configuration and/or flag for the first mode of operation (e.g., SBFD) may be configured as part of resource allocation configuration for a Tx/Rx occasion.

In an example, a WTRU may be configured with one or more types of slots. The WTRU may be configured with a first slot with a first type, where the first type may be for example SBFD slot. The WTRU may be configured with a second slot with a second type, where the second type may be for example non-SBFD slot. As for the first slot with the first type (SBFD), the WTRU may be configured with one or more DL, UL, flexible, guard, etc. sub-bands in the frequency domain, throughout the BWP, for the duration of the first slot. However, in the second slot with the second type (non-SBFD), the WTRU may be configured with only one direction type, for example DL, UL, flexible, etc., in the frequency domain, throughout the BWP, for the duration of the second slot.

In an example, if the WTRU is configured with a second slot with UL direction, this implies legacy TDD UL slot, UL-only slot, and/or non-SBFD UL slot. In another example, if the WTRU is configured with a third slot with second type (non-SBFD) with DL direction, this implies legacy TDD DL slot, DL-only slot, and/or non-SBFD DL slot. In another example, if the WTRU is configured with a fourth slot with second type (non-SBFD) with flexible direction, this implies legacy TDD flexible slot and/or non-SBFD flexible slot, and so forth.

In an example, the WTRU may be configured with a SBFD ‘DU’ configuration, referring to a configuration where the upper-frequency sub-band of the cell's carrier is configured as a Downlink sub-band, while the lower-frequency sub-band of the same cell's carrier is configured as an Uplink sub-band. One or more guard-band (i.e., unused frequency resources) may be configured at the edge of the cell's carrier or in between sub-bands.

In an example, the WTRU may be configured with a SBFD ‘UD’ configuration, referring to a configuration where the upper-frequency sub-band of the cell's carrier is configured as an Uplink sub-band, while the lower-frequency sub-band of the same cell's carrier is configured as a Downlink sub-band. One or more guard-band (i.e., unused frequency resources) may be configured at the edge of the cell's carrier or in between sub-bands.

In an example, the WTRU may be configured with a SBFD ‘DUD’ configuration, referring to a configuration with three sub-bands and both the upper-frequency and lower-frequency sub-band of the cell's carrier is configured as Downlink sub-bands, while the middle-frequency sub-band of the same cell's carrier is configured as an Uplink sub-band. One or more guard-band (i.e., unused frequency resources) may be configured at the edge of the cell's carrier or in between sub-bands.

In an example, the WTRU may be configured with a SBFD ‘UDU’ configuration, referring to a configuration with three sub-bands and both the upper-frequency and lower-frequency sub-band of the cell's carrier is configured Uplink sub-bands, while the middle-frequency sub-band of the same cell's carrier is configured as a Downlink sub-band. One or more guard-band (i.e., unused frequency resources) may be configured at the edge of the cell's carrier or in between sub-bands.

A WTRU may receive configurations of (e.g., may be configured with) SBFD sub-band time locations that may be configured within a period. In an example, the period may be the same as TDD-UL-DL pattern period configured by dl-UL-TransmissionPeriodicity, e.g., in TDD-UL-DL-ConfigCommon. In an (e.g., another) example, the period may be an integer multiple of TDD-UL-DL pattern period configured by dl-UL-TransmissionPeriodicity, e.g., in TDD-UL-DL-ConfigCommon.

When a (e.g., one, only one) TDD-UL-DL pattern is configured, SBFD symbols may be configured in consecutive manner within a TDD-UL-DL pattern period. When two TDD-UL-DL patterns are configured and if SBFD symbols are configured for only one of the patterns, SBFD symbols may be configured in consecutive manner within the TDD-UL-DL pattern period. When two TDD-UL-DL patterns are configured and if SBFD symbols are configured for both patterns, SBFD symbols may be configured in consecutive manner within each TDD-UL-DL pattern period.

In a dynamic SBFD configuration, a WTRU may be configured with one or more SBFD configurations, changing over time. The WTRU may receive multiple configurations for different SBFD patterns, such as one or more DU, UD, DUD or UDU patterns. The WTRU may receive the configuration to apply a time pattern where different of these SBFD configurations are used over time. In an example, the period may be the same as TDD-UL-DL pattern period configured by dl-UL-TransmissionPeriodicity, e.g., in TDD-UL-DL-ConfigCommon. In an (e.g., another) example, the period may be an integer multiple of TDD-UL-DL pattern period configured by dl-UL-TransmissionPeriodicity, e.g., in TDD-UL-DL-ConfigCommon.

A WTRU may be configured with a dedicated SBFD configuration, where the WTRU receives, e.g., via RRC dedicated signaling, the SBFD configuration to apply on selected time resources. This may apply the same pattern and periods as the RRC (re)configuration TDD-UL-DL-ConfigDedicated field.

A WTRU may be configured with multiple (serving) cells, e.g., for Carrier Aggregation (CA), and in the case of Dynamic SBFD configuration, the WTRU may be configured with different SBFD configuration at the same time across different cells.

In the network, geographically neighboring cells (that may be controlled by different gNBs or nodes) may be configured with independent SBFD configuration, for example, using different SBFD patterns and/or different sub-band size and position configuration. The network may be able to exchange information about the configuration of the different cells between gNBs.

A WTRU may determine (or be indicated/configured with) that ‘UL usable PRBs’ are a part of UL sub-band frequency resources within an UL BWP (e.g., an active UL BWP, a currently active UL BWP), and ‘DL usable PRBs’ are a part of DL sub-band frequency resources within an DL BWP (e.g., an active DL BWP, a currently active DL BWP). The UL usable PRBs may be determined as an intersection between a configured or indicated UL sub-band and an active UL BWP in SBFD symbols (and/or slots). The DL usable PRBs may be determined as an intersection between a configured or indicated DL sub-band(s) and an active DL BWP in SBFD symbols (and/or slots). In an (e.g., another) example, the UL and/or DL usable PRBs may be explicitly configured within active UL and/or DL BWP, e.g., in SBFD symbols and/or slots.

In an example, a WTRU may receive information on frequency resource allocation (e.g., Type 0 as RBG-level bitmap-based resource assignment) for a PDSCH or PUSCH (as being scheduled) in a slot(s). When an assigned RBG overlaps with a sub-band boundary, the WTRU may determine that (only) the PRBs within DL usable PRBs are to be valid for PDSCH reception and (only) the PRBs within UL usable PRBs are to be valid for PUSCH transmission, e.g., where this may imply “partial RBG” is allowed and valid for resource allocation.

A WTRU may receive configurations (e.g., from a gNB, a node, or a device) for full-duplex (FD) operation conducted by at least one device in a network. In an example, the FD operation may be conducted by a gNB (e.g., a BS, a node, a TRP, a cell). The WTRU may operate in a half-duplex (HD) mode for communicating with the gNB, where the HD mode may imply at a given time that the WTRU either performs a UL transmission or a DL reception (not both simultaneously at the given time). The WTRU may (also) operate in an FD mode for communicating with the gNB, e.g., if a corresponding WTRU capability signal(s) is reported to the gNB and/or the WTRU receives a confirmation signal (e.g., enabling the FD, configuring the FD mode) in response to transmitting the WTRU capability signal(s).

The FD operation may imply at a given time a transmitter (e.g., the gNB and/or the WTRU) may simultaneously transmit a first signal and receive a second signal. The FD operation may comprise a sub-band overlapping FD (e.g., in-band FD (IBFD)) operation where a first frequency-domain resource (e.g., RBG(s), RB(s), RE(s)) allocated for the first signal may have a full (or at least a partial) overlap with a second frequency-domain resource allocated for the second signal. The FD operation may comprise a sub-band non-overlapping FD (SBFD) operation where a first frequency-domain resource allocated for the first signal (for example, assigned within a configured SBFD sub-band, e.g., DL sub-band, usable DL PRBs) does not have an overlap with a second frequency-domain resource allocated for the second signal (for example, assigned within a configured SBFD sub-band, e.g., UL sub-band, usable UL PRBs).

Hereafter, for the brevity of discussion, FD operation may comprise the SBFD operation, however the solutions and examples described may equally (or equivalently or extendedly, etc.) be employed (e.g., applicable) for cases with other FD operation types (e.g., IBFD, etc.).

A WTRU may receive SBFD-related configuration(s), for example, for frequency-domain location information of one or more sub-bands (e.g., DL sub-band, UL sub-band, flexible DL/UL sub-band, and/or guard band), and/or for time-domain location information of the one or more sub-bands. The time-domain location information may indicate a set of non-SBFD symbols and a set of SBFD symbols (e.g., as illustrated in FIG. 3). A symbol(s) within the set of non-SBFD symbols may be a type of ‘DL symbol’, ‘UL symbol’ or ‘flexible symbol’. The WTRU may receive a DL signal on symbol(s) based on a type of ‘DL symbol’ in the set of non-SBFD symbols. The WTRU may transmit a UL signal on symbol(s) based on a type of ‘UL symbol’ in the set of non-SBFD symbols. The WTRU may either receive a DL signal or transmit a UL signal on symbol(s) based on a type of ‘flexible symbol’ in the set of non-SBFD symbols, e.g., depending on one or more conditions with other signal(s) co-existing in the symbol(s).

A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

A WTRU may receive a synchronization signal/physical broadcast channel (SS/PBCH) block. The SS/PBCH block (SSB) may include a primary synchronization signal (PSS), a secondary synchronization signal (SSS), and a physical broadcast channel (PBCH). The WTRU may monitor, receive, or attempt to decode an SSB during initial access, initial synchronization, radio link monitoring (RLM), cell search, cell switching, and so forth.

A WTRU may measure and report the channel state information (CSI), wherein the CSI for each connection mode may include or be configured with one or more of: a CSI Report Configuration, a CSI-RS Resource Set, and NZP CSI-RS Resources.

A CSI Report Configuration may include one or more of the following: CSI report quantity, for example, Channel Quality Indicator (CQI), Rank Indicator (RI), Precoding Matrix Indicator (PMI), CSI-RS Resource Indicator (CRI), Layer Indicator (LI), etc., CSI report type, e.g., aperiodic, semi persistent, periodic, CSI report codebook configuration, e.g., Type I, Type II, Type II port selection, etc., and CSI report frequency.

A CSI-RS Resource Set may include one or more of the following CSI Resource settings: a NZP-CSI-RS Resource for channel measurement, a NZP-CSI-RS Resource for interference measurement, and a CSI-IM Resource for interference measurement

NZP CSI-RS Resources may include one or more of the following: NZP CSI-RS Resource ID, periodicity and offset, QCL Info and TCI-state, and resource mapping, e.g., number of ports, density, CDM type, etc.

A WTRU may indicate, determine, or be configured with one or more reference signals. The WTRU may monitor, receive, and measure one or more parameters based on the respective reference signals. For example, one or more of the following parameters may apply. It should be understood that following parameters are non-limiting examples of the parameters that may be included in reference signal(s) measurements. One or more of these parameters may be included, and other parameters may also be included.

Synchronization signal (SS) reference signal received power (SS-RSRP) may be measured based on the synchronization signals (e.g., demodulation reference signal (DMRS) in PBCH or SSS). It may be defined as the linear average over the power contribution of the resource elements (RE) that carry the respective synchronization signal. In measuring the RSRP, power scaling for the reference signals may be required. In the case where SS-RSRP is used for L1-RSRP, the measurement may be accomplished based on CSI reference signals in addition to the synchronization signals.

CSI-RSRP may be measured based on the linear average over the power contribution of the resource elements (RE) that carry the respective CSI-RS. The CSI-RSRP measurement may be configured within measurement resources for the configured CSI-RS occasions.

SS signal-to-noise and interference ration (SS-SINR) may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.

CSI signal interference to noise (CSI-SINR) may be measured based on the linear average over the power contribution of the resource elements (RE) that carry the respective CSI-RS divided by the linear average of the noise and interference power contribution. In case where CSI-SINR is used for L1-SINR, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth)

Cross-Layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, and so forth). In the case where L1-CLI-RSSI is used, the WTRU does not perform L3 filtering over multiple measurement samples, which may help identify time bursts of interferences.

Sounding reference signals RSRP (SRS-RSRP) may be measured based on the linear average over the power contribution of the resource elements (RE) that carry the respective SRS. In the case where L1-SRS-RSRP is used, the WTRU does not perform L3 filtering over multiple measurement samples, which may help identify time bursts of interferences.

A WTRU may be configured, determined, or indicated to perform a measurement of cross-link interference (CLI) Received Signal Strength Indicator (RSSI) in a given time period, where the given time period may be one or more slots, OFDM symbols, resource blocks (RBs), and/or resource elements (Res). The CLI-RSSI which may be measured in a given time and/or frequency resource may be referred to as L1-CLI-RSSI, short-term CLI-RSSI, aperiodic CLI-RSSI, and so forth. Alternatively, the WTRU may be configured, determined, or indicated to perform a measurement of Reference Signal Received Power (RSRP) based on one or more reference signals (e.g., SRS-RSRP) in the context of CLI measurement in a given time period, wherein the given time period may be one or more slots, OFDM symbols, resource blocks (RBs), and/or resource elements (REs). The SRS-RSRP which may be measured in a given time and frequency resource may be referred to as L1-SRS-RSRP, short-term SRS-RSRP, aperiodic SRS-RSRP, SRS-RSRP-CLI, and so forth.

Herein, the terms CLI-RSSI, L1-CLI-RSSI, and RSSI may be interchangeably used but still consistent with the description. Herein, the terms SRS-RSRP, SRS-RSRP-CLI, L1-SRS-RSRP, and RSRP may be interchangeably used but still consistent with the description.

One or more RSSI (or RSRP) types may be used and a WTRU may be configured to perform one or more RSSI (or RSRP) types, wherein a first RSSI (or RSRP) type may be based on a measurement over a long time period (for example, more than one slot) (e.g., L3 measurements) and the measurement is reported via a higher layer signaling (e.g., RRC, MAC); and a second RSSI (or RSRP) type may be based on a measurement over a short time period (e.g., L1 measurements) (for example, one slot, within a slot, one or more OFDM symbols within a slot) and the measurement is reported via a L1 signaling (e.g., PUCCH, PUSCH, RACH, SRS). RSSI may be interchangeably used with RSRP, RSRQ, and SINR. CLI-RSSI may be interchangeably used with SRS-RSRP and SINR.

The WTRU may be configured with one or more sets of time and frequency resources for measuring CLI, for example, SRS-RSRP (e.g., a new IE SRS-RSRP-MeasurementResourceSet) containing one or more sets of configuration information of SRS-RSRP measurement resource(s) (e.g., SRS-RSRP-MeasurementResource), for example, for L1 SRS-RSRP measurement. The SRS-RSRP measurement resource configurations may include number of SRS ports, transmission comb, time resource mapping such as start position, number of symbols, repetition, frequency resources, frequency hopping, resource type such as periodic, aperiodic, semi-persistent, sequence ID used for SRS, and so forth.

The WTRU may be configured with one or more sets of time and frequency resources for measuring CLI, for example, CLI-RSSI (e.g., a new IE CLI-RSSI-MeasurementResourceSet) containing one or more sets of configuration information of CLI-RSSI measurement resource(s) (e.g., CLI-RSSI-MeasurementResource), for example, for L1 CLI-RSSI measurement. The CLI-RSSI measurement resource configurations may include CLI-RSSI measurement resource ID, starting PRB index, number of PRBs, starting symbol of the CLI-RSSI resource within a slot, number of symbols of the CLI-RSSI resource within a slot, periodicity and slot offset for the CLI-RSSI resource, and so forth.

Hereafter, for the brevity, the CLI measurement may comprise the CLI-RSSI measurement, however the solutions and examples in described may equally (or equivalently or extendedly, etc.) be employed (e.g., be applicable) for cases with other interference and/or CLI measurements (e.g., SRS-RSRP, CLI-RSRP, etc.).

The WTRU may be configured with a set of time and frequency resources to measure L1-CLI-RSSI, where the time and frequency resources for L1-CLI-RSSI measurement may be referred to as CLI-RSSI Measurement Resource (CRMR).

The CRMR may be a resource configured, determined, or defined (e.g., via RRC, MAC-CE, DCI) (e.g., via CLI-ResourceConfig, CLI-ResourceConfig-r-16, and so forth) with one or more properties as follows.

A set of muted REs in downlink resource (e.g., PDSCH), where the muted Res may be rate-matched around or punctured for downlink reception and/or uplink transmission. The set of muted Res may have a same pattern (e.g., same time and frequency location) in each RB. The set of muted Res may have a different pattern based on the RB location, for example, a first pattern may be used for the RBs located in an edge of the scheduled RBs and a second pattern may be used for the RBs located in a center of the scheduled RBs. The first pattern and the second pattern may have a different number of muted RES. The muted Res may be in a form of zero-power resources (e.g., CSI-RS and/or ZP-CSI-RS)

A set of REs not scheduled or used for the WTRU measuring CRMR.

A set of REs may be located in an RB which may be configured or determined as guard band (or guard RB). A guard band (or guard RB) may be located in between uplink and downlink resources. A WTRU may skip receiving or transmitting a signal in guard band.

One or more reference signals (e.g., DMRS, SRS, sidelink CSI-RS, etc.).

A second set of DMRS REs within a second CDM group (e.g., within a scheduled downlink resource and/or RBs, e.g., of PDSCH), where a WTRU may receive a DCI scheduling the PDSCH, indicating a first set of DMRS REs corresponding to a first CDM group to be used for receiving the PDSCH. In an example, the WTRU may receive the DCI, scheduling the PDSCH, indicating a first set of DMRS REs corresponding to a first CDM group (based on an indicated ‘(DMRS) antenna port’ field of the DCI. In response to receiving the DCI, the WTRU may determine that a second set of DMRS Res within a second CDM group (other than the first CDM group) may be used as the CRMR (e.g., within the scheduled PDSCH).

Located within a scheduled resource (e.g., scheduled PDSCH RBs)

The CRMR may be configured commonly for a set of WTRUs (e.g., UEs in proximity). For example, a gNB may configure a CRMR for a group of WTRUs, wherein the group of WTRUs may share one or more of following: a group-ID to receive a DCI (e.g., a group-RNTI); a zone-ID, wherein the zone-ID may be determined based on a geographical location of the WTRU (e.g., GNSS), and WTRUs paired for sidelink unicast (or groupcast) transmission

L1-CLI-RSSI measurement (including CRMR resource) may be considered as CSI reporting quantity and configured as a part of CSI reporting setting.

The CRMR may be configured in a first sub-band type (e.g., DL sub-bands) to measure the (effect of) one or more reference signals received in a second sub-band type (e.g., UL sub-bands). As such, the reference signals may be received and measured in resources that can be identified as zero-power or muted resources. The WTRU may be configured, determined, or indicated to measure the effect of reference signals being transmitted in other resources (e.g., second type resources, e.g., UL sub-bands) in these resources (e.g., first type resources, e.g., DL sub-bands). For example, a first WTRU may be configured to measure SRS-RSRP in DL sub-bands on an SBFD configuration, where the SRS is transmitted by a second WTRU in the UL sub-bands. In an example, the first WTRU may measure SRS-RSRP based of the configured SRS signaling in the DL sub-bands. In another example, the WTRU may measure the CLI-RSSI based on the configured SRS signaling in the UL sub-bands.

Delta-CLI measurement. The WTRU may be configured, determined, or indicated to perform a delta CLI-RSSI, which may be based on a first CLI-RSSI measurement in a first time and/or frequency location and a second CLI-RSSI measurement in a second time and/or frequency location. One or more of following may apply: the delta CLI-RSSI (delta-CLI-RSSI) may be a difference between a first CLI-RSSI (e.g., CLI-RSSI1) and a second CLI-RSSI (e.g., CLI-RSSI2), e.g., delta-CLI-RSSI=CLI-RSSI1-CL-RSSI2 (or delta-CLI-RSSI=CLI-RSSI2-CL-RSSI1, etc.); the first CLI-RSSI may be measured from CRMR resources located in the edge of the scheduled RBs while the second CLI-RSSI may be measured from CRMR resources located in the middle of the scheduled RBs; a WTRU may be configured with a first CRMR resource for the first CLI-RSSI measurement and a second CRMR resource for the second CLI-RSSI measurement; and a WTRU may determine to report CLI measurement related information when a measured delta-CLI-RSSI is larger than a threshold. For example, CLI reporting may be triggered based on delta-CLI-RSSI measurement is larger than a threshold, wherein the threshold may be predetermined or configured.

The WTRU may be configured or determine to measure CLI-RSSI per sub-band level. For example, a sub-band may be configured, or predetermined and a WTRU may perform CLI-RSSI measurement in each sub-band.

One or more of following may apply: sub-band size may be determined based on the number of scheduled RBs (e.g., for PDSCH); the WTRU may report CLI-RSSI measurement for all sub-bands; and the WTRU may report a subset of CLI-RSSI, wherein the subset may be determined based on one or more conditions (e.g., CLI-RSSI value above threshold, sub-band location (e.g., edge of scheduled RBs), and/or sub-band index).

The WTRU may determine a bandwidth of beam measurement and/or reporting (e.g., wideband or sub-band) based on one or more of following conditions: a time unit type (e.g., SBFD or non-SBFD), for example, a WTRU may report wideband CRI (e.g., wideband beam index) in non-SBFD time units (e.g., symbol, slot, and so forth) and the WTRU may report sub-band CRI (e.g., sub-band beam index) in SBFD time units; and the presence of CLI-RSSI measurement. The bandwidth of beam measurement/reporting is determined based on whether CLI-RSSI is measured in the same slot or not.

The WTRU may be indicated to perform CLI-RSSI measurement in a specific frequency location within a scheduled RBs (or non-scheduled RBs), wherein the specific frequency location may be one or more of sub-bands, RBs, and REs. The indication may be in a DCI which may trigger the CLI-RSSI measurement (e.g., aperiodic CLI-RSSI measurement). The specific frequency location may be indicated based on the CRMR resource frequency location. For example, one or more CRMR resources may be configured and each CRMR resource may be located in a specific frequency location based on configuration. The WTRU may be indicated to perform measurement on CRMR resource indicated in a DCI.

Hereafter, wordings such as “the WTRU is configured,” “the WTRU is preconfigured,” “the WTRU received a configuration,” and “the WTRU received a pre-configuration” may be interchangeably used; meaning that the WTRU may receive an indication from the network, either from RRC (re)configuration, MAC indication, DCI signaling or MIB/SIB indication, which can be explicit or implicit, based on the specification, or that the WTRU has an internal setting or default setting of the configuration without additional network signaling.

Hereafter, when a WTRU is using a parameter value such as threshold for determination of whether a condition is met or not, the WTRU may be assumed to have received the (pre)configuration of the corresponding threshold beforehand, e.g., from the network.

Hereafter, wordings such as “Aggressor WTRU” refers to the WTRU that generates interferences (CLI) to another WTRU (“victim WTRU”). Reciprocally, the “Victim WTRU” refers to the WTRU that receives the interference (CLI) from the aggressor WTRU, for example as illustrated in FIG. 2.

In a special case, e.g., if the WTRU is capable of SBFD or FD operations, the aggressor WTRU and victim WTRU may be the same WTRU, and the CLI becomes Self-Interference or Self-interference Leakage.

A WTRU (aggressor) may monitor some pre-configured resource for CLI indication from other WTRUs. The WTRU may determine which CLI indication resources to monitor based on its recent UL transmissions. Upon reception of a CLI indication from another WTRU, the WTRU (aggressor) is triggered to send an SRS to assist CLI identification, for example, based on mapping between past transmission or based on information in the CLI indication.

A WTRU (victim) may transmit a CLI indication after the detection of a CLI on a DL reception/measurement on a resource determined based on a first mapping. The WTRU then performs SRS-RSRP measurement on the SRS resources based on a second mapping and report to the network.

The WTRU may include in the CLI indication a power offset to be used for the SRS transmission, and compensate that power when reporting to the network, for example, based on the received CLI level.

The WTRUs may both receive a (pre)configuration with the same mapping for the CLI indication and SRS monitoring resources so that they may both have a common understanding of when/where to perform the transmissions without reconfiguration.

Note that although the description focuses on SBFD operations for 5G and 5G advanced, similar procedure may apply on other duplexing systems such as 6G, for example, for dynamic TDD/SBFD, in-band/overlapping full duplex, XDD, WTRU-based SBFD, etc.

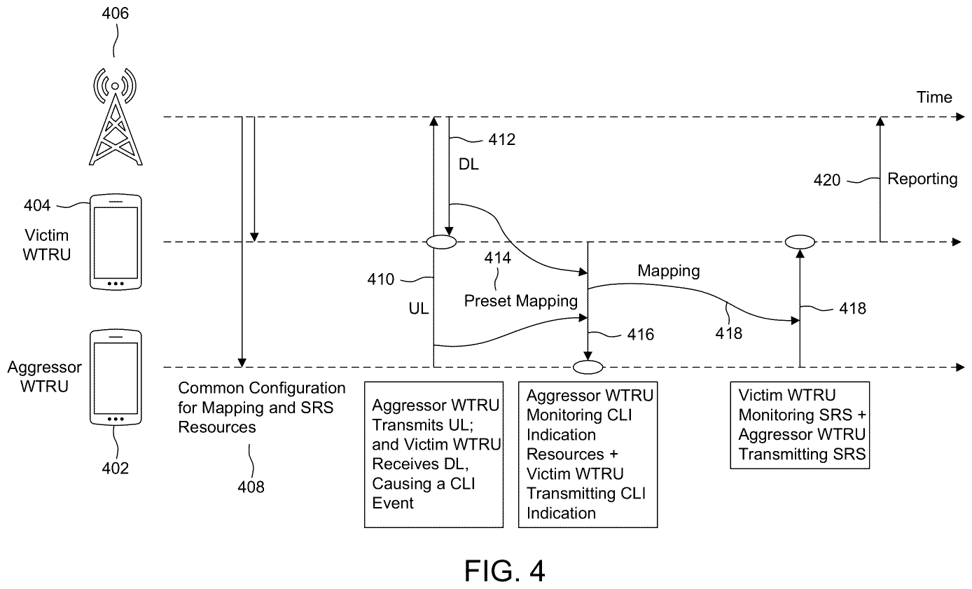

FIG. 4 illustrates an overview of the interaction between an aggressor WTRU and a victim WTRU. WTRU 402 (aggressor) and WTRU 404 (victim) may receive a common configuration for mapping and SRS resources 408 from a base station (e.g., gNB 406). WTRU 402 may transmit UL signal 410 while WTRU 404 receives DL signal 412. WTRU 402 may be configured to monitor for a CLI indication after transmission of the UL signal as described below.

Upon experiencing an CLI event, WTRU 404 may transmit CLI indication 416 on configured resources 414 and WTRU 402 may monitor for the CLI indication on the configured resources. Upon detecting the CLI indication, WTRU 402 may transmit a reference signal 418 on the configured resources, for example, configured SRS resources. WTRU 404 may receive reference signal 418. Based on reference signal 418, WTRU 420 may transmit a report 420 to notify the network of the CLI and the identify of WTRU 402.

WTRU 402 may be configured to monitor and determine the resources to measure a CLI indication after an UL transmission 410. The CLI indication 416 may be (directly) sent from another WTRU (WTRU 404) and indicate that WTRU 404 received significant CLI. Receiving the CLI indication 416, WTRU 402 may perform associated CLI management (e.g., CLI handling, pre-defined or pre-configured) actions such as transmitting an SRS 418 for CLI measurement/identification.

In one example, WTRU 402 may receive an indication 408 from the network (gNB 406) indicating the configurations for the reception/monitoring of CLI indications. The (pre)configuration 408 includes at least the format and resources on which to perform monitoring the CLI indication.

The WTRU may receive a configuration for one or more resources for CLI indications. The resources may be UL resources, i.e., in an UL band or sub-band, or resources that may be configured for UL transmissions. The UL resources may be on SBFD slots/symbols, non-SBFD symbols/slots, FD, XDD or any duplexing resources.

The resources may be on resources for WTRU to WTRU communications, for example, on SL resources such as SL resource pools, or any resources that the WTRU may use or be configured to use for WTRU to WTRU transmissions.

The resources may be a resource without a dedicated or configured duplexing direction, e.g., for technologies where the duplexing is flexible, (dynamically) configurable and/or where the transmission and reception resources may overlap, at either network or WTRU side.

The resources may be configured as periodic resources or semi-persistent resources, where a periodicity parameter is given to the WTRU. The resources may be configured based on the transmission resource patterns, e.g., where the CLI indication is following the UL transmissions resources. For example, similarly with a HARQ feedback resource mapping, an CLI indication resource may be configured with respect to UL resources.

The WTRU may receive the configuration for the format of the CLI indication. The CLI indication may be transmitted as a signal/sequence or as data carrying the information. In some examples, the CLI indication may be a sequence, that can be an existing RS that the WTRUs are transmitting, for example, for other purposes, and repurposed for the CLI indication when that transmission is on CLI indication resources. The RS may be based on UL RS (SRS, UL DMRS, UL PTRS, etc.) or SL RS (SL SSB, SL DMRS, etc).

In an example, the WTRU may receive the configuration that the CLI indication is transmitted as an SRS, based on a received regular SRS configuration, e.g., referenced by the SRS index or resource index/resource set index. In such a case, the SRS that WTRUs measure for the other WTRUs' SRS for CLI measurement is already supported, reducing the impact on other WTRUs. For other existing RS, the WTRU may similarly receive the configuration parameters associated to the RS, for example, formats, sequence indices, time/frequency resources etc. based on the configured RS.

In another example, the WTRU may receive a new signal/sequence configuration dedicated to CLI indication, that may include the signal/sequence type (Gold, Zadoff-Chu (ZC) sequence, etc.), offsets, index, frequency density, positions and size, time density, position and size, etc.

In an example, the CLI indication may be configured as a PRACH-like transmission such as a ZC sequence within a configured time/frequency window.

The CLI indication may be a dedicated data transmission or embedded in a data transmissions. This may be a PUCCH, a PUSCH, or a PSCCH/PSSCH

The WTRU may receive the configuration that the CLI indication is included in a PUCCH, e.g. in a long PUCCH or short-PUCCH. In one example, the CLI indication may be sent in a UCI including the CLI indication, e.g., as part of a UCI message content or as a dedicated new UCI message. In another example, the CLI indication is the HARQ feedback corresponding to a given transmission. E.g., A NACK value corresponding to the WTRU receiving CLI above the threshold.

The WTRU may receive the configuration that the CLI indication is included in a PUSCH. For example, a the CLI indication is included in a MAC CE indication or a standalone indication included in the PUSCH.

The WTRU may receive the configuration that the CLI indication is included in a PSCCH. For example, a the CLI indication is included in a SCI signaling as part of an additional parameter in the SCI or as a new SCI format dedicated to CLI indication via SL.

The WTRU may receive the configuration that the CLI indication is included in a PSCCH. For example, the CLI indication is included in a SL MAC CE indication or a standalone indication included in the PUSCH. As PSSCH may also include SCIs, the CLI indication may also be configured as a SCI indication or parameter within a SCI sent over the PSSCH.

The PSCCH/PSSCH may be unicast, targeting a single WTRU (e.g., indicated as destination ID in the SCI), e.g., if the WTRU transmitting the CLI indication knows the source of the CLI. The source ID in the SCI is the WTRU transmitting the CLI indication.

The PSCCH/PSSCH may be groupcast, targeting a group of WTRUs, for example, either the WTRU knows the WTRU source and it is part of the group, of if a SL group of WTRUs is configured to monitor for CLI indication. The source ID in the SCI is the WTRU transmitting the CLI indication.

The PSCCH/PSSCH may be a broadcast transmission, e.g., if the WTRU doesn't know the source of CLI and/or if the WTRU does not have an active connection to that WTRU.

The WTRU may receive the configuration for the CLI indication using RRC signaling, e.g., via a dedicated CLI indication IE; a MAC signaling, e.g., via a dedicated MAC CE message and/or DCI indication.

There are different ways the WTRU may be triggered/configured to determine the resources and monitoring a CLI indication. In one common aspect, the WTRU is triggered/configured to monitor CLI indication following an UL transmission.

In an example embodiment, the WTRU may be (pre)configured with a set of CLI indication resources, e.g., semi-periodic/periodic resource on which to monitor for CLI indication, and (pre)configured with a mapping rule between an UL transmission and a resource from the set of CLI indication. After the WTRU performs an UL transmission, the WTRU may determine if the transmission triggers a CLI indication monitoring based on UL transmission conditions (e.g., being in SBFD resources) and the WTRU may determine the CLI indication resources based on the mapping and the performed UL transmission, and monitor the determined CLI indication resources.

The WTRU may receive one, multiple or combination of the configuration activation/deactivation of the feature or configuration for mapping. Upon reception of the CLI indication monitoring activation, the WTRU may start the monitoring of the CLI indication resources. Upon reception of the CLI indication monitoring deactivation, the WTRU may stop the monitoring of the CLI indication resources. The WTRU may receive the (de)activation indication explicitly or implicitly.

In an example, the WTRU receives the configuration for the feature, e.g., the CLI indication resource configuration, or the mapping between the UL transmission and the CLI indication resource, and based on receiving the configuration, the WTRU assumes that the feature is activated.

In an example, the WTRU may receive a configuration for CLI indication resources that are semi-persistent, and the activation/deactivation, e.g., via RRC/MAC/DCI signaling, implicitly indicates the activation/deactivation of the CLI indication monitoring.

In another example, the WTRU may receive an explicit indication for activation/deactivation of the feature, e.g., via RRC/MAC CE/DCI indication.

In another example, the WTRU may receive an explicit indication for activation and/or deactivation of the feature by a multicast (or broadcast) signaling transmitted to a group of WTRUs, e.g., via a group-common DCI such as DCI format 2_0. This may provide a benefit in that the network may turn ON or OFF of this feature WTRU-group-specifically, based on an overall CLI level in a cell area.

The WTRU may receive the mapping configuration between an UL transmission, i.e. the UL transmission resources and the CLI indication resource. The mapping may be, for example, based on at least one of following.

The CLI resource mapping may be configured as a one-to-one mapping, i.e., for each time/frequency resource of the UL transmission, a corresponding CLI indication resource. This allows easy identification for the WTRUs and a WTRU monitoring that resource would be able to directly determine the transmission corresponding to the CLI indication, but this may require a lot of resources.

The CLI resources mapping may be configured as a many-to-one mapping, i.e., multiple time/frequency resources of the UL transmission may correspond to one CLI indication resource. The regrouping resources use less overhead but may create ambiguity in the identification of the CLI.

The CLI resources mapping may be configured as a one-to-many mapping, i.e., one time/frequency resource of the UL transmission may correspond to multiple CLI indication resources. This may allow better reliability and redundancy of the CLI indication at the cost of increased overhead resources. This could be used, for example, with different CLI indication transmission parameters such as beams, to be able to reach WTRUs in different areas.

The CLI resources mapping may be configured as a time and/or frequency offset with respect to the time/frequency resources of the UL transmission, for example, offsets as a number of symbols/slots and as a number of REs/RBs.

The CLI resources mapping may be configured within a set of CLI indication resources. The different CLI resources may be identified and differentiated by their time, frequency, code, sequence index, shift, etc; and may be assigned with different indices, each corresponding to a possible UL transmission resource. This would allow the regrouping all of the CLI indications in a limited time/frequency resource area for monitoring.

At least one method of the above CLI resources mapping may be applied separately (e.g., independently, differently, based on corresponding configuration/indication) per channel or signal (e.g., PUCCH, PUSCH, SRS, PSCCH, PSSCH, PRACH, etc.), and/or per channel or signal's type (e.g., Type1-CG-PUSCH, Type2-CG-PUSCH, DG-PUSCH, PUCCH for CSI reporting, PUCCH with HARQ-ACK, and so on, based on configuration or indication)

In an example embodiment, to avoid large overhead or systematic CLI indication monitoring, the WTRU may receive a configuration to determine whether to monitor for a CLI indication after an UL transmission based on certain conditions. The WTRU may receive the condition configuration, for example, which conditions and the corresponding parameters, e.g., thresholds, through RRC, MAC or DCI signaling. Conditions may include one, more or a combination of the following conditions.

For SBFD resources, the WTRU may determine to monitor for the CLI indication if the UL transmission is in SBFD symbols/slots. SBFD-related CLI mainly impact another WTRU when the transmission is in SBFD resources.

In an example, the WTRU may be configured to monitor for a CLI indication whenever it has an UL transmission in a SBFD slot/symbol.

In another example, the WTRU may be configured to monitor for a CLI indication whenever it has an UL transmission in a selected subset of SBFD slot/symbol configuration, e.g., restricted to any subset of the possible SBFD configurations {DU, DUD, UD, UDU}.

In a broader scope example, the WTRU may be configured to monitor for CLI indication whenever it has an UL transmission in any selected subset of duplexing slot/symbol configuration, including FD, XDD, overlapping FD, non-overlapping FD, SBFD, WTRU-side SBFD, etc.

The conditions may include frequency distance between UL transmission and DL resources. The WTRU may be configured to trigger/monitor for CLI indication when the UL transmission is scheduled in resources that are close (in the frequency domain) to DL resources. For example, the WTRU may receive a configuration indicating a frequency distance threshold between the transmission and the DL resources, and if the frequency distance is smaller, the WTRU triggers the monitoring.

The conditions may include a transmission type. The WTRU may receive the configuration to monitor for the CLI indication for a subset of transmissions, e.g., whether the UL transmission was a PUSCH, PUCCH, UL RS, PRACH, etc. In one example, the WTRU may be configured to only monitor for CLI indication after transmitting PUSCH and PRACH, or any other combination.

The WTRU may receive the configuration to monitor for the CLI indication for some UL transmissions, based on the transmission configuration, e.g., whether the transmission is periodic, semi-periodic, aperiodic/dynamic, and/or whether the transmission triggered by a configured grant or a dynamic grant. In an example, the WTRU may be configured to trigger the CLI indication monitoring only for periodic/semi-periodic or configured grants (e.g., any transmission that is not dynamically scheduled by the network).

The conditions may include WTRU positions. The WTRU may receive the configuration to monitor for the CLI indication for transmissions when the WTRU is located in selected positions. For example, the WTRU may be configured to monitor for CLI indication when in the cell-edge.

In another example, the WTRU may be configured to monitor for CLI indication when close to other WTRUs (e.g., using a threshold in distance between the WTRUs or based on thresholds on signal quality/strength received from another WTRU).

The conditions may include measurements. The WTRU may receive the configuration to monitor for the CLI indication based on SSB, CSI-RS etc measurements, e.g., to measure the pathloss to the cell.

In an example, the WTRU may monitor for CLI indication after an UL transmission if the serving cell measurement is below a given threshold, e.g., indicating that the WTRU is far from the cell center.

In another example, the WTRU may monitor for CLI indication after an UL transmission if a neighboring cell measurement is higher a given threshold, e.g., indicating that the WTRU is far from other cells.

The WTRU may receive the configuration to monitor for the CLI indication for transmissions using a transmit power beyond a received configuration threshold. The purpose being that a WTRU is more likely to cause CLI when its transmit power is high.

The WTRU may receive the configuration to monitor for the CLI indication for transmissions using a selected set of UL beams, e.g., identified via a beam ID, or a RS used for reference for the beams/spatial filters. The purpose being that a WTRU may cause CLI when it transmits towards other WTRUs, or depending on the situation, if the beam is towards the cell edges or the cell center, etc.

Conditions may include the measured CLI. The WTRU may receive the configuration to monitor for the CLI indication for transmissions when the WTRU measured CLI from another WTRU beyond a threshold, for example, based on (L1-)CLI-RSSI or (L1-)CLI-SRS-RSRP measurements, or if the WTRU is aware of CLI or potential CLI from another WTRU (e.g., based on network indication). The purpose being that CLIs are likely symmetrical, and if the WTRU receives CLI from another WTRU, it likely may cause CLI to that other WTRU.

Combinations of criterions may also be used as a criterion for CLI indication monitoring, such as a combination of the cell measurement, position and TX power, e.g.

To monitor for SBFD CLI, the WTRU may receive an configuration as a combination of resource position (e.g., threshold of frequency distance between UL transmission and the DL sub-band on the SBFD resources) and TX power. The rational being that the leakage of interference reduces with frequency distance, so the more frequency distant the transmissions are, the TX power criterion may be higher, and a combination of both criterions may need to be fulfilled to trigger the CLI indication monitoring.

For neighboring cell CLI monitoring, the WTRU may be configured with criterion on both position/pathloss (e.g., being on cell-edge) and the position/pathloss to another neighboring cell and/or transmit power. For instance the farther from a neighboring cell the WTRU is, the higher the TX power criterion may be configured. It should be appreciated that the above conditions/criterions are not limiting and that other combinations are not precluded.

After an UL transmission, the WTRU may verify whether the UL transmission triggers the CLI monitoring, based on the received configuration and criterions. If the conditions and criterions are valid (for example, the UL resources are in SBFD resources and the transmit power is beyond a given threshold), the WTRU is triggered to monitor for CLI indications.

In another embodiment, the WTRU may be (pre)configured with a set of CLI indication resources, e.g., (semi-periodic/periodic resource on which to monitor for CLI indication, and (pre)configured with a mapping rule between an UL transmission and a resource from the set of CLI indication resources. The WTRU may then receive an UL transmission command from the network (e.g., dynamic or configured grant) including an indication to monitor for the CLI indication resource for that transmission, using the (pre)configured mapping.

In an example, the WTRU may be configured with semi-periodic/periodic transmissions, e.g., via RRC signaling and/or MAC activation/deactivation signaling. The semi-periodic/periodic transmission configuration may include an indication that these transmissions trigger a CLI indication monitoring, e.g., using a flag/binary parameter. When the WTRU performs the transmission(s) corresponding to these configured transmissions, the WTRU is triggered to monitor for CLI indication.

In another example, the WTRU may receive a DCI granting an UL transmission and the DCI may include a flag/binary indication for the WTRU to trigger the monitoring of CLI indication for that transmission.

In another embodiment, the WTRU may be (pre)configured with a set of CLI indication resources, e.g., semi-periodic/periodic resource on which to monitor for CLI indication. The WTRU may then receive an UL transmission command from the network (e.g., dynamic or configured grant) including an indication of the CLI indication resource to monitor.

In an example, the WTRU may be configured with semi-periodic/periodic transmissions, e.g., via RRC signaling and/or MAC (de)activation signaling. The semi-periodic/periodic transmission configuration may include an indication that these transmissions trigger a CLI indication monitoring and a mapping indication to one of the configured CLI indication resources, e.g., using an index or offset, a delay between the transmission and a CLI indication resource or a resource assignment targeting. When the WTRU performs the transmission(s) corresponding to these configured transmissions, the WTRU is triggered to monitor for CLI indication on the indicated resources.

In another example, the WTRU may receive a DCI granting an UL transmission and the DCI may include a mapping indication to one of the configured CLI indication resources, e.g., using an index or offset, a delay between the transmission and a CLI indication resource or a resource assignment targeting. When the WTRU performs the transmission(s) corresponding to these configured transmissions, the WTRU is triggered to monitor for CLI indication on the indicated resources.

In another embodiment, the WTRU may receive a CLI indication resource and an UL transmission command from the network (e.g., dynamic or configured grant), jointly or separately, indicating that the CLI resource may be monitored for that UL transmission.

In one example, the WTRU may be configured with semi-periodic/periodic transmissions, e.g., via RRC signaling and/or MAC (de)activation signaling. The semi-periodic/periodic transmissions configuration may include an indication that these transmissions trigger a CLI indication monitoring and a mapping rule to indicate the CLI indication resources to monitor, e.g., using a delay or a resource assignment, a time/frequency rule between the UL transmission and a CLI indication resource. When the WTRU performs the transmission(s) corresponding to these configured transmissions, the WTRU is triggered to monitor for CLI indication on the indicated resources.

In another example, the WTRU may receive a DCI granting an UL transmission and the DCI includes and a mapping indication to a CLI indication resource, e.g., using an index or offset, a delay between the transmission and a CLI indication resource, or a direct resource assignment for CLI indication resource, e.g., indicating the time and frequency position of the CLI resource dynamically. When the WTRU performs the transmission(s) corresponding to these configured transmissions, the WTRU is triggered to monitor for CLI indication on the indicated resources.

The WTRU may perform a transmission, for example, on UL resources, that is based on a received dynamic or configured grant, e.g., based on a DCI grant, a RRC and/or MAC configuration. The transmission may be a PUSCH, PUCCH, UL RL or any other signal.

In an example embodiment, when triggered or configured to monitor for CLI indication after a transmission, e.g., based on determined criterions or indicated by the network, the WTRU determines the CLI indication associated with the UL transmission resources. The WTRU may determine the CLI indication resources based on the configuration/trigger. In some examples, the WTRU may determine the CLI indication resources corresponding to a transmission based on the following examples.

In an example, when the WTRU triggers the CLI monitoring based on (pre)configured resources and criterions, the WTRU uses the received Configuration for mapping between the UL transmission resources and the CLI indication resources and the transmission triggering the CLI monitoring, for example, using a mapping or offset between the time of the UL transmission resource and the CLI indication resource.

In another example, when the WTRU triggers the CLI monitoring based on an indication of which CLI indication resource received in the grant/configuration of the transmission to use, the WTRU may determine the CLI resource using the pre-configured CLI resource and the indicated resource, for example, the indication may indicate an offset, a number of resource to wait, a timing indication to point to one of the (pre)configured CLI resource.

In another example, when the WTRU triggers the CLI monitoring based a received CLI indication resource indicated directly in the grant/configuration of the transmission, the WTRU may use the indicated resource directly.

In an example embodiment, the WTRU may determine the reception configuration associated with the CLI indication resource, for example, based on the CLI indication resource itself and/or based on the UL transmission that triggered the CLI indication monitoring. For example, the WTRU may determine a spatial filter or reception beam to monitor the CLI indication resource based on the transmit parameters of the UL transmission that triggered the monitoring. In another example, the WTRU may use the same spatial filter or beam as it used to perform the UL transmission. In yet another example, the WTRU may determine a set of spatial filters or reception beams to monitor the CLI indication resources to perform a beam-sweeping on various CLI indication resources and be able to monitor/receive more accurately the indication.

In an example embodiment, the WTRU monitors the determined CLI indication resources for a signal or transmission. The WTRU may perform a variety of measurements or data reception, e.g., based on the received CLI indication configuration.

In a baseline example, the WTRU may perform an energy detection or power level measurement on the determined resource, e.g., using (L1)RSRP, (L1)RSSI, (L1)SINR. The WTRU may be configured with a threshold and compare the measurement to the threshold to determine whether a signal was transmitted on that resource. If the measurement is beyond the threshold, the WTRU may determine that it received a CLI indication, and trigger the actions following CLI indication. The energy/power level based detection provides a simple to implementation but lacks reliability, for example, identifying of the source of the CLI indication.

In an example, the WTRU the energy/power detection is performed on a sequence/signal, e.g., a dedicated transmission signal for CLI indication. In another example, the WTRU performs energy/power detection is performed on a data transmission, e.g., on a resource including a PUSCH, PUCCH, PSSCH, PSCCH, PRACH, etc.

In an example, the WTRU may be receiving a (pre)configured sequence or RS. The WTRU monitors the resource for the corresponding sequence/signal, using the receive configuration for the signal. The WTRU may determine that it received the CLI indication if it is able it retrieve the sequence, and/or if the measurement is beyond a (pre)configured threshold.

For example, if using SRS-based measurement, the WTRU may perform (L1-)SRS-RSRP measurement and use the configure SRS time/frequency/index information to determine the monitoring/measurement configuration of the signal to receive. The SRS-based CLI indication provides a more accurate measurement of the SRS and may be able to identify the WTRU that suffered from CLI. In another example, the WTRU may be monitoring and decoding data transmission from the other WTRU on determined resource.

In an example embodiment, the WTRU is configured to monitor/decode HARQ feedback from the other WTRU, for example, the WTRU first determined the HARQ feedback resources of a transmission that would collide with the transmission it performed, and monitor that HARQ feedback. The WTRU may determine a CLI indication if the HARQ feedback included a NACK. In one example, the WTRU is configured to monitor/decode PUCCH/PUSCH/PSCCH/PSSCH channels sent from other WTRU, and receive information.

The WTRU may receive a CLI indication including information (implicitly or explicitly) as described below.

The WTRU may be configured to perform a transmission when receiving a CLI indication. This is mainly an implicit indication from the reception of the CLI indication itself. The CLI indication may further indicate, in some options/examples: the transmission to perform, for example, a SRS, by indicating a SRS resource and/or resource set, e.g., from a list of (pre)configured possible resources, a sequence/index to use etc. The SRS may be (re)configured to use an indicated index/sequence, for example, the index of the WTRU sending the CLI indication, the index of the aggressor WTRU, or another index that the WTRU will recognize as an index for CLI indication response.

In an example, the WTRU may receive an CLI indication include the measured CLI, e.g., reporting value such as (L1)CLI-RSSI or (L1-)SRS-RSRP, or a new indication for quantifying the CLI level (e.g., few bits to indicate a gradient of strong/weak CLI, based on configured thresholds).

In one example, the WTRU may receive a CLI indication including the resources or transmissions that was impacted by the CLI. For instance, the WTRU may receive the indication of time and/or frequency resources overlapping with the UL transmission. This may be beneficial to know the overall transmission impacted and not only the resource over the UL transmission causing the CLI.

In an example, the WTRU may receive a CLI indication including preferred or non-preferred resources, e.g., so that the WTRU may favor or avoid the indicated resources for following transmissions. In one example, the WTRU may receive a CLI indication including preferred or non-preferred beams, e.g., so that the WTRU may favor or avoid the indicated beams for following transmissions.

In an alternative embodiment, the WTRU may receive the CLI indication from the network, e.g., receiving the indication via MAC (e.g., via a new MAC CE message) or DCI indication (e.g., via a new parameter in a DCI), and when configured to monitor for network-based indication, the WTRU monitors PDCCH for DCIs and possibly PDSCH carrying MAC CEs.

In an embodiment, when the WTRU receives a CLI indication, the WTRU may determine whether to trigger actions, such as performing an SRS transmission. The WTRU may make the determination based on one or more of the below example.

The CLI indication may include an indication to send (or not to send a response), for example, a SRS transmission. In one aspect, if the CLI indication includes an explicit indication for SRS transmission, the WTRU may determine to transmit based on that received parameter. If there is no such parameter (implicit indication), the WTRU may determine to transmit the SRS upon reception of the CLI indication itself.

In one aspect, the WTRU may determine to transmit a SRS following the reception of the CLI indication if the CLI indication is received with high enough power/energy. For example, the WTRU may be configured with a power threshold and may compare the signal received power, whether it is simply energy detection, power level (e.g. RSSI) or specific source power (e.g. RSRP or SINR), to the threshold. If the received power is higher than the configured threshold, the WTRU may determine to transmit the SRS. The rational being that with reciprocity, a strong CLI indication power likely indicates that the CLI itself was received with strong power.

In another aspect, the WTRU may be configured with a set of index or reference parameters, and when receiving the CLI indication, the WTRU compares a received index or parameter with the reference set. If the received index is included in the set, the WTRU triggers the SRS transmission, otherwise it doesn't. For example, the WTRU may be configured with a set of SRS sequence indices, and when receiving the CLI indication as an SRS, the WTRU may verify the received sequence index. The given set of index may be configured by the network to indicate a subset of WTRUs with which to perform the CLI indication procedure.

When the conditions or criterions are met, the WTRU triggers the transmission of the SRS in response to the CLI indication. It should be appreciated by those skilled in the art that although the description primarily refers to SRS transmission, any reference signal (RS) or like signal that the WTRU may transmit for the other WTRU to measure may similarly apply without limitation, and the specific signal's transmission parameter may be used. The RS may be based on UL RS (SRS, UL DMRS, UL PTRS, etc.), SL RS (SL SSB, SL DMRS, etc) or dedicated signal/sequence, and the WTRU receives the (pre)configuration related to the transmission of these signals (resource, format, content, etc.)

The SRS resources may be configured periodically or semi-periodically with a configured periodicity, e.g., using RRC configuration and/or MAC (de)activation.

The WTRU may receive the indication that the SRS resource(s) (or a subset of the SRS resources) may be used for CLI mitigation purposes, e.g., a flag/bitfield in the SRS resources, resource set or based on a usage indication.

The WTRU may not always perform the transmission in the SRS resources, for example, the WTRU may use the SRS resource when triggered to perform the CLI mitigation procedure, e.g., after receiving a CLI indication or request from the WTRU or network to transmit on these resources.

In one example, the WTRU determines the resources to perform the SRS transmission that is intended to transmit back to the victim WTRU. The WTRU may determine the SRS resource based on a (pre)configured mapping, e.g., received from the network; but also based on the received CLI indication and/or the UL transmission that triggered the CLI indication monitoring. Several examples are described below, and one or more of the example may be combined.

The WTRU may be (pre)configured with a mapping between the CLI indication resources and one or more SRS resources received by the network, for example, using RRC configuration. The WTRU may, based on the resources of the CLI indication and the received mapping, determine the resource(s) for the SRS transmission. For example, the mapping may correspond to a delay between the CLI indication resource and a (pre)configured SRS resource, or the first (pre)configured SRS resource that is following a minimum delay. As another example, the mapping may correspond to a frequency mapping between the CLI indication resource and a (pre)configured SRS resource from a set of SRS resource(s), for example, ordered by SRS resource index.

The WTRU may be (pre)configured with a mapping between the UL transmission resources and one or more SRS resources, e.g., received by the network using RRC configuration. The WTRU may, based on the resources of the UL transmission that triggered the CLI indication monitoring and the received mapping, determine the resource(s) for the SRS transmission.

For example, the mapping may correspond to a delay between the UL transmission resource and a (pre)configured SRS resource, or the first (pre)configured SRS resource that is following a minimum delay. As another example, the mapping may correspond to a frequency mapping between the UL transmission resource and a (pre)configured SRS resource from a set of SRS resource(s), e.g., ordered by SRS resource index.

The WTRU may determine the SRS resource(s) to use for the transmission based on an indication received in the CLI indication. The WTRU may receive in the CLI indication complementary information as described below.

An SRS resource set may be used. If present, the WTRU may determine the SRS resource(s) to use from the indicated SRS resource set in the CLI indication. The WTRU may use one or more resource(s) depending on either the indication or pre-configured mappings or combinations of mapping and SRS resource set indication.

An SRS resource(s) may be used. If present, the WTRU may determine the SRS resource(s) to use based on the CLI indication. The SRS resource(s) may be an independent SRS resource or a resource from a (pre)configured or indicated set of SRS resources. For example, the WTRU determines the SRS resource as a combination of the mapping between the CLI indication and a SRS resource set, and a received SRS resource index within the resource set from the CLI indication.

A WTRU identification may be used. If present, the WTRU may determine the SRS resource(s) or SRS resource set based on the WTRU identification (for example, a configured mapping between WTRU identification to SRS resources/resource set), the WTRU identification may be the UE ID, RNTI, a transformation on a UE ID/RNTI (e.g., taking only a subset of the bits or scrambling the ID for security/privacy) or simply based on a list of indexes that WTRUs are configured with from the network that represent the WTRU or a WTRU group for this feature.

In an example embodiment, the WTRU may determine the SRS sequence index to use for the SRS transmission, based on its received configuration or based on the CLI indication resources, the UL transmission, and/or information in the CLI indication.

In one example, the WTRU may be configured with SRS resources with a specific SRS sequence index, and simply use the SRS sequence index received as a configuration.

In another example, the WTRU may use a sequence index linked to its UE ID, e.g., using a received configured index for the CLI mitigation SRS transmissions. This would enable another WTRU monitoring the SRS to determine the source of the CLI. The index may be based on the UE ID, RNTI, etc., and a processed version of its IDs (e.g., a subset of bits) or could also be received as a configuration from the network.

In another example, the WTRU may receive a sequence index to use for the SRS transmission, so that the other WTRU that requests to use a specific sequence (to reduce processing and be able to identify which SRS it is expected to measure).

The WTRU may further determine the SRS transmission parameters, e.g., transmit power and transmit beam as described below.

The WTRU may use a (pre)configured transmit power or beam, for example, as a received from the network (e.g., using RRC/MAC signaling) for the SRS transmission for CLI mitigation.

The WTRU may determine the transmit power or the beam of the SRS to be the same as the transmit power and beam used for the transmission that triggered the CLI indication. The purpose being that the WTRU receiving the SRS may monitor and have a good comparison with the CLI event. If the previous transmission caused CLI, the SRS with the same power will likely be received correctly as well.

The WTRU may determine the transmit power to use based on the transmit power control loop of the corresponding SRS, for example, based on past transmissions power of the same SRS.

The WTRU may determine the transmit power of the SRS is based on transmit power of the transmission that caused the CLI event and an indication configured by the network that the WTRU received as part of the configuration. In one example, the WTRU receives a power offset (e.g., −3 dB) and applies the offset to the past transmit power to determine the total transmit power. The purpose of the offset is for the network to control the SRS transmission power to avoid strong interferences and/or to manage the transmissions based on the network topologies and WTRUs.

The WTRU may determine the transmit power of the SRS is based on transmit power of the transmission that caused the CLI event and an indication received in the CLI indication, i.e., from the victim WTRU. In one example, the WTRU may receive, in the CLI indication, an indication of transmit power for the SRS, for example, either an absolute transmit power or an offset to apply. The WTRU may use the indicated transmit power for the SRS or use the indicated power offset with respect to the past transmit power.

In an embodiment, the WTRU transmits an SRS on the determined resources and using the determined transmit beam and power, triggered by the received CLI indication and using the determined sequence index, and the transmit power and beam indicated by the (pre)configuration.

In following description section the “victim WTRU” is described. The victim WTRU is the WTRU that receives CLI from another (aggressor) WTRU.

A WTRU may be configured to transmit a CLI indication, requesting the CLI source to transmit an SRS (or other signal) for CLI measurement. This way, the WTRU may alert other WTRUs of the received CLI and may identify the CLI source and report the CLI source to the network.

In an embodiment, the WTRU may receive an indication from the network indicating the configuration for the transmission of CLI indications. The (pre)configuration includes at least the format and resources on which to perform the CLI indication. The configuration is similar to the one described with respect to the WTRU receiving configuration for receiving a CLI indication as described above.

In addition, the WTRU may receive a configuration indicating the transmit power for the CLI indication. In one example, the WTRU may be configured with a constant transmit power, e.g., set by the network. In another example the CLI indication may be configured to be transmitted with its maximum available transmit power.

In an example embodiment, the WTRU triggers the transmission of a CLI indication based on a CLI event, and based on the resources/transmissions on which the CLI happened. Examples CLI events are described below.

A WTRU may detect a CLI based on a measurement. The WTRU may be configured to perform a CLI measurement on some resources, for example, the WTRU may receive the measurement configuration from the network. The measurement may be based on RSSI and/or RSRP measurements.

In an example, the WTRU may determine that it detected a CLI event when the CLI measurement is beyond a configured threshold (e.g., based on (L1-)CLI-RSSI measurement).

For a network measurement, the WTRU may be configured to perform a (non-CLI) measurement, e.g., RS (CSI-RS, DMRS, SSB, . . . ) measurement. In an example, the WTRU detects that it received CLI, e.g., based on the measurement being lower than a threshold, e.g., based on (L1)-RSRP or (L1-)SINR. In another example, the WTRU may determine that it received CLI due to a combination of measurements metrics and thresholds, e.g., the RSSI is beyond a threshold while the RSRP/SINR is below a threshold.

In still another example, the WTRU may detect a CLI if the measurement of a network signal, for example, based on RSRP or SINR value having a change over time. For example, this may be based on a threshold on a delta/difference on the metrics. Other combinations of measurements and thresholds are possible.

The WTRU may detect a CLI based on a failed receptions. The WTRU may be configured to trigger a CLI indication when a scheduled DL reception failed to be received correctly.

As an example, the WTRU may be configured with a DL grant with some transport format based on its link quality with the network. If the WTRU could not correctly decode the transmission while the link quality was estimated to be good enough, the WTRU may determine that a CLI happened on the DL resources. For example, if the MCS is low and link quality is good, the likelihood of failure is low, so a reception failure may indicate a CLI. The WTRU may consider one or a configured number of failure within a configured window of time to consider the CLI.

In another example, the WTRU may be configured to trigger a CLI indication when a specific scheduled DL reception failed and the WTRU was configured by the network to trigger CLI indication for that DL reception. For example, the network may be aware of potential CLI and provide an indication in the DL assignment (DCI, MAC or RRC depending on the grant and dynamic/configured scheduling assignment) and add a signaling/parameter that for this transmission, the WTRU determines a CLI if the reception failed.

The WTRU may detect a CLI on SBFD resources. If the WTRU performed strong interference measurements or detected DL failures, the WTRU may determine that these are due to CLI if the measurements or failure happened in SFBD resources. Similarly, the WTRU may determine the CLI event if the resources where in full duplex, overlapping duplex, XDD, etc. types of resources, where same-cell WTRU may cause CLI to the WTRU.

A WTRU may detect a CLI according to a transmission type. The WTRU may trigger a CLI indication depending on the received signal/transmission. Some example are provided below.

The WTRU may trigger a CLI indication when the CLI happened on a selected (sub)set of receptions, e.g., over a PDCCH, over a DL RS, over a SSB, over a PDSCH, and possibly depending on the priority of the reception.

The WTRU may trigger a CLI indication when the CLI happened on receptions that are not dynamically scheduled, e.g. (semi-)periodic receptions. The WTRU may trigger a CLI indication when the CLI happened on receptions that are dynamically scheduled.

A WTRU may detect a CLI according to WTRU positions. The WTRU may trigger a CLI indication for transmissions when the WTRU is located in selected positions. For example, the WTRU may trigger a CLI indication when in the cell-edge (e.g., using a threshold in distance between the network and the WTRU, or as a threshold in network signal strength/quality). In another example, the WTRU may trigger a CLI indication when close to other WTRUs (e.g., using a threshold in distance between the WTRUs or based on thresholds on signal quality/strength received from another WTRU).

In an embodiment, the WTRU determines the resources for the CLI indication based on the received CLI. This aspect has many similarities with the WTRU determining the resources to monitor CLI indications described above, which can be reused here, but where the WTRU determines the resources based on the received CLI or DL reception instead of the UL transmission.

For instance, the WTRU may determine the CLI indication resources based on pre-configured resources and a mapping between the resources that received the CLI and the CLI indication resources. In another example, the WTRU may determine the CLI indication resources based on a network indication, for example, when indicating that the WTRU may transmit CLI indication in response to CLI event detection. The resources may be received through the DL reception assignment (DCI, MAC, RRC).

The WTRU may determine transmission parameters for the CLI indication, for example, based on the transmit power and beam, the received CLI, or on the received transmission/performed measurement.

In an example, the WTRU may use the transmit beam corresponding to the receiving beam of the reception used during the CLI event. In another example, the WTRU may use a (pre)configured beam for CLI indications, for example, the CLI indication configuration includes a beam or TCI index associated for the CLI indication.

In an example, the WTRU may use a transmit power based on the received and/or measured CLI event. For instance, if the measured CLI is below a power threshold, the WTRU uses a first transmit power, if it is higher than the threshold, it uses a second transmit power. The rational being that if the CLI is strong, it is likely that the source of the CLI is not far and a lower transmit power is sufficient to reach it.

In another example, the WTRU may use a (pre)configured transmit power for CLI indications, for example, the CLI indication configuration includes an associated transmit power. A fixed transmit power may help the determination of a pathloss between the WTRUs to evaluate their respective impact.

In an example embodiment, the WTRU may perform the transmission of the CLI indication on the determined resources, and based on the received configuration for CLI indication, for example, related to the format and content. Some examples are described below.

In an example, the WTRU may transmit a (pre)configured dedicated sequence, an RS (e.g. UL SRS). The WTRU may transmit on the determined resource for the corresponding sequence/signal, using the receive configuration for the signal. In another example, the WTRU may be transmitting information on the determined resource.

In an example, the WTRU is configured to transmit HARQ feedback on its PUCCH resources. In another example, the WTRU is configured to transmit the CLI indication over PUCCH/PUSCH/PSCCH/PSSCH channels.

The WTRU may transmit a CLI indication including information (implicitly or explicitly). A WTRU may receive a request to perform a transmission. This is mainly an implicit indication from the reception of the CLI indication itself. The CLI indication may further indicate the resources to perform the transmission, e.g., for an SRS:

The CLI indication may indicate an SRS resource and/or resource set, e.g., from a list of (pre)configured possible resources. The WTRU may select an SRS from its configured resources, for example, based on a timing between the CLI event and the SRS resources, or based on ongoing scheduling to avoid overlaps with other transmissions.

The CLI indication may indicate a sequence or index to use etc. The WTRU may select an SRS sequence to monitor, so that the WTRU can reduce the complexity of the subsequent SRS measurement. The index may be selected based on the UE ID or based on a received configuration.

In an example, the WTRU may transmit an CLI indication including the measured CLI, for example, reporting a value such as (L1)CLI-RSSI or (L1-)SRS-RSRP, or a new indication for quantifying the CLI level (e.g., few bits to indicate a gradient of strong/weak CLI, based on configured thresholds).

The CLI indication may indicate resources impacted by the CLI. In an example, the WTRU may transmit a CLI indication including the resources or transmissions that was impacted by the CLI. For instance, the WTRU may send the indication of time and/or frequency resources overlapping with the CLI.

The CLI indication may indicate preferred or non-preferred resources. In an example, the WTRU may transmit a CLI indication including preferred or non-preferred resources, e.g., so that the aggressor WTRU may favor or avoid the indicated resources for following transmissions.

The CLI indication may indicate preferred or non-preferred beams. In one example, the WTRU may transmit a CLI indication including preferred or non-preferred beams, e.g., so that the WTRU may favor or avoid the indicated beams for following transmissions.

In an example embodiment, the (victim) WTRU may determine to include a transmit power indication in the CLI indication, that the aggressor WTRU may use to transmit its SRS afterwards. The purpose of this indication is to calibrate the SRS reception correctly from the (victim) WTRU side and avoid large/low CLI measurement values that could alter the overall measurement and receptions at that time. Some examples are provided below.

The WTRU may determine a transmit power value to be indicated to the other WTRU, so that the WTRU may evaluate the pathloss between the WTRUs and have a good reference.

In an example, if WTRU is triggered due to CLI measurement (e.g. a CLI-RSSI beyond a threshold), the WTRU may determine transmit power based on the measurement. For example, if the measurement is less than a first threshold, the transmit power is a first value, if the measurement is beyond the threshold, the transmit power is another value (also applicable with more thresholds and values)

In an example, the WTRU has a (pre)configured value for the SRS transmission and indicates that value. The WTRU may determine a transmit power offset relative to the transmission causing the CLI, to be indicated to the other WTRU. The offset may be used to tune the SRS monitoring so that the measurement is in a good range and/or avoid strong interference in the network.

In an example, if WTRU is triggered due to CLI measurement (e.g. a CLI-RSSI beyond a threshold), the WTRU may determine transmit power offset based on the measurement. The stronger the CLI-RSSI, the lower the transmit power offset so that the received power in subsequent measurement is in a good range and avoids generating interference in the network.

In one example, if WTRU is triggered due to failures in DL receptions, and if some measurements are available on the DL reception signals (SINR, RSRP, . . . ), the WTRU may also determine a power offset based on measured interference, and, for example, use thresholds to set values for the transmit power offsets.

After the WTRU transmits the CLI indication, the WTRU prepares to monitor and measure an SRS (or any other configured signal) from the aggressor WTRU, based on the CLI event and/or the transmitted CLI indication.

In an example embodiment, the WTRU may be (pre)configured with SRS resource(s) for CLI monitoring. The SRS resources may be configured periodically or semi-periodically with a configured periodicity, e.g., using RRC configuration and/or MAC (de)activation.

The WTRU may receive the indication that the SRS resource(s) (or a subset of the SRS resources) may be used for CLI mitigation purposes, for example, by a flag/bitfield in the SRS resources, resource set or based on usage indication

The WTRU may not always perform the measurement in the SRS resources, e.g., the WTRU may measure the SRS resource when triggered/determined to perform the CLI mitigation procedure, for example, after transmitting a CLI indication. The SRS measurement may be based, for example, on (L1-)CLI measurement configuration. For example, based on (L1-)SRS-RSRP measurement. The WTRU may receive the configuration for measurement reporting, e.g., resources, formats and content expected for the SRS-based measurement, associated with the SRS measurement/resources.

In an example embodiment, the WTRU determines the SRS resources to monitor, based on received configuration, CLI event, and/or transmitted CLI indication. This determination is similar with the one where the aggressor WTRU determines the SRS resources based on received CLI indication and configuration as described above, but where the resources used for the mapping between the CLI and the SRS are based on the measured CLI event or resources of the DL reception that suffered from CLI; and where this WTRU is the one that determined/transmitted the CLI indication instead of receiving it. The WTRU may then performs the configured SRS-based measurement on the determined resources, using the received configuration.

In an example embodiment, the WTRU may determine the source (aggressor WTRU) of the SRS transmission, hence determine the source of the CLI. For example: the WTRU may determine the aggressor WTRU based on the sequence of the received SRS. For example, the WTRU may be monitoring several possible SRS resources or SRS sequences, each corresponding to an ID. The WTRU may have received a mapping between the IDs and the corresponding resources/sequences. The IDs may or may not reflect the actual UE ID in the network (RNTI, . . . ) for security reasons this ID be an internal mapping from the network. When receiving the SRS, the mapping may be applied to determine the ID of the source. The WTRU may determine the source of CLI for SRS measurement are beyond a given threshold (e.g. based on (L1-)SRS-RSRP) to avoid false-alarm or reporting low sources of CLI.

In an example embodiment, the WTRU may report to the network the measured CLI/SRS, e.g., using the received reporting configuration. The report may the information described below.

The report may include a measurement value (e.g., based on SRS-RSRP, CLI-RSSI, etc.)

In an example embodiment, if the WTRU determined/indicated a transmit power or transmit power offset in the CLI indication, the WTRU may use this to adjust the measurement performed. For example, if the WTRU indicated a transmit power offset in the CLI indication, e.g., −3 dB, the WTRU may compensate for the offset and apply an opposite offset, e.g., +3 dB, to the measured value to reflect the measurement corresponding to the actual CLI. In another example, if the WTRU indicated a transmit power in the CLI indication, the WTRU may determine the pathloss by deducting the transmit power from the received power. The WTRU may also report the indicated transmit power or transmit power offset

The SRS resource on which the WTRU received the SRS transmission, e.g., if the resource was not explicitly or uniquely indicated by the network configuration, the WTRU may indicate which resource was used for the SRS measurement.

The report may include a sequence of the received SRS transmission, e.g., if the sequence was not explicitly or uniquely indicated by the network configuration, the WTRU may indicate which sequence was used for the SRS.

The report may include the determined ID of the source of the SRS transmission, e.g., if the WTRU determined a source based on the received SRS, the WTRU may report that source ID.

The report may include the CLI event, e.g., how the WTRU detected/determined the CLI and/or on which resources/which DL reception.

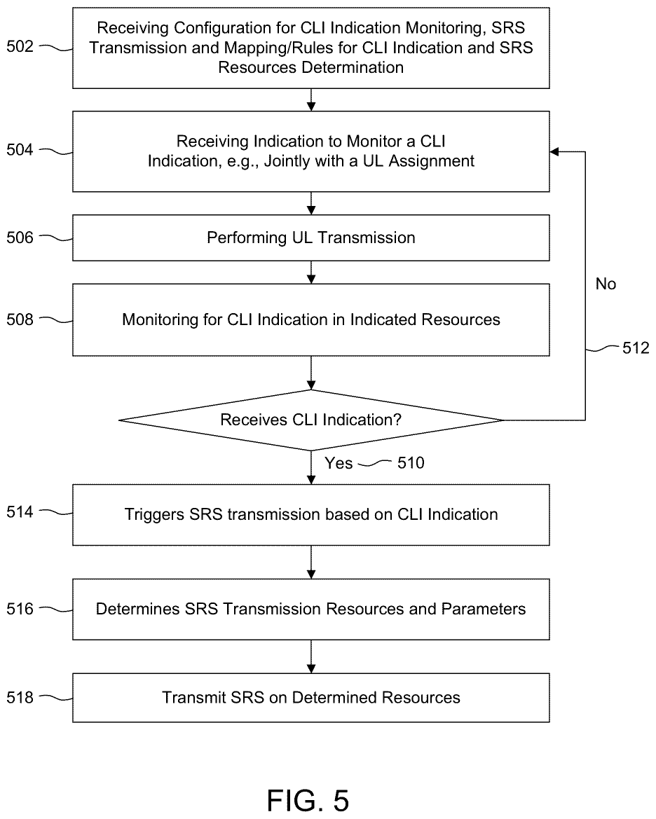

FIG. 5 illustrates a WTRU triggering SRS transmission based on reception of CLI indication from another WTRU as described above.

A WTRU (aggressor) may be configured to monitor a CLI indication after an UL transmission. The CLI indication is typically sent from another WTRU and indicates that the other WTRU received significant CLI. Receiving the CLI indication, the WTRU may be triggered to perform the associated CLI management actions such as transmitting an SRS for CLI measurement/identification, and determine the SRS resource using (pre)configured mapping.

The WTRU may receive indication on whether its transmission causes CLI and quickly respond with an SRS transmission, without requiring WTRU-network reports and multiple WTRU reconfigurations.

At 502, a WTRU may receive the configuration/pre-configuration, for example, from the network using RRC. The configuration/pre-configuration may include a set of SRS resources for transmission, for example, semi-periodic/periodic resources, and the configuration may include a mapping rule between a CLI indication and a corresponding SRS resource. The mapping rule may, for example, include the time of the SRS resource is the earliest resource after the transmission and a delay/offset, and/or comb/freq/shift/code may be dependent on time/frequency resource.

At 504, the WTRU may receive a command (e.g., DCI) for UL transmission including an indication to monitor for a CLI indication following the transmission. The indication may include: time/frequency resources of the CLI indication to monitor, and the signal to monitor may be, for example, a dedicated sequence, an UL RS, a PUCCH/PUSCH etc. It is noted that this could be an explicit configuration or a pointer to a (pre)configured CLI indication configuration.

The WTRU may perform UL transmission at 506, according to the received UL parameters, for example in an UL grant. At 508, the WTRU may monitor the resources indicated in the grant assignment and trigger a SRS transmission based on detecting a CLI indication on the monitored resources. The monitoring may include measuring the energy level on the CLI indication resources and detect the energy is higher than a configured threshold, e.g., based on RSSI levels or measuring the energy or power level of the configured sequence and detects that the energy/power is beyond a configured threshold, e.g. based on RSSI, RSRP, SINR, etc. at 510. In a case where the energy or power level is not higher that the threshold value, at 512 the WTRU may return to the process at 504, and the WTRU may receive may another indication to monitor for a CLI at 504.

Based on the measurement result, the WTRU may determine reception of a CLI indication, and at 514 the WTRU may trigger CLI management actions such as transmitting an SRS or similar signal for CLI measurement/identification. At 516, the WTRU may determine the SRS (or another signal) resources to use for SRS transmission, for example, based on the configured mapping between the CLI indication and the SRS resources, and SRS transmission parameters (502). The SRS transmission parameters may include a transmit power and a transmit beam. For example, the transmit power and beam may be the same as the UL transmission initiating the CLI indication monitoring. At 518, the WTRU may transmit the SRS using the determined transmission parameters.

A WTRU (victim) may transmit a CLI indication after the detection of a CLI event detected on a DL reception/measurement, on resource determined based on a first mapping. The WTRU then performs CLI measurements (e.g. SRS-RSRP) on the resources based on a second mapping and report to the network.

The (victim) WTRU may include additional information in the CLI indication such as SRS transmit power indication, SRS sequences or SRS resources to indicate the expected SRS monitoring parameters to the other WTRU.

The WTRU may allow the WTRU to directly request another WTRU to perform an SRS transmission to measure CLI and identify the CLI source without multiple reports and reconfigurations to/from the network.

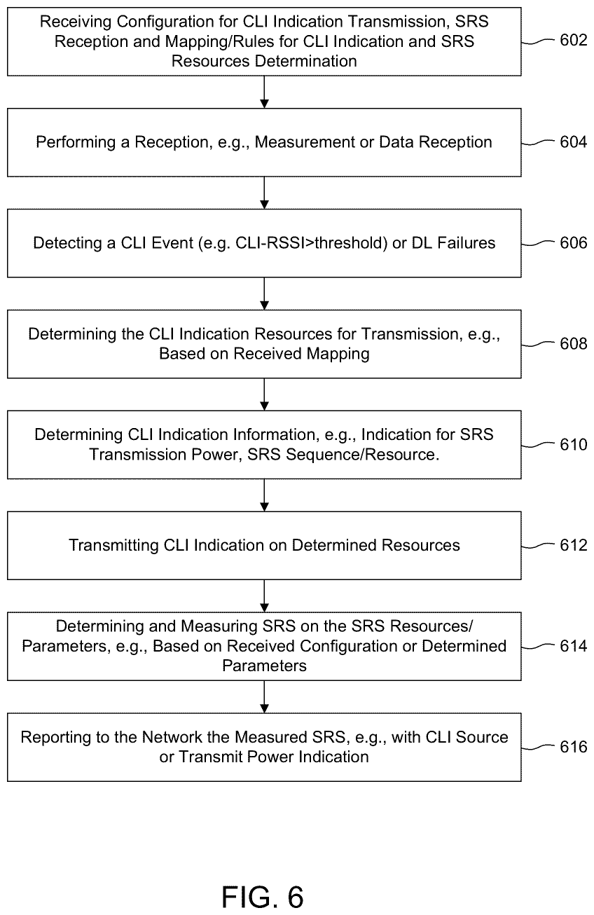

FIG. 6 illustrates a process of a WTRU requesting another WTRU for SRS transmission and performing CLI measurement.

The WTRU may receive a configuration with (e.g., via RRC configuration) at 602. The configuration may include conditions to perform the transmission which may include a CLI-RSSI measurement above a threshold and corresponding measurement configuration and resources, and/or a threshold on a number of DL reception (PDCCH/PDSCH) failures.

The configuration may include resources for transmitting a CLI indication. This may include a set of UL resources and format to be monitored after an UL transmission, for example, monitoring resources are periodic resources. The configuration may include a set of SRS resources to measure, for example, periodic resources.

The configuration may include a first mapping between a CLI event and the UL transmission resources, for example, the first UL resource after the CLI event plus a first minimum delay, and the configuration may include a second mapping between a CLI event and the SRS resources to monitoring, for example, the first SRS resource after the CLI event plus a second minimum delay. Thus, two mappings may be configured, and it should be appreciated that either mapping may be referred to as a first or a second mapping.

At 604, a WTRU may perform a reception of, for example a data reception or measurement, an detect a CLI event that may trigger performing a CLI management process. The trigger may be based on: a measured CLI-RSSI is above a threshold; a number of DL reception (PDCCH/PDSCH) failure within a window higher than a threshold, or SBFD resources for DL failure at 606. The WTRU may determine the resource to transmit the CLI indication based on the mapping between the CLI and UL transmission resources at 608.

The WTRU may determine CLI indication information at 610. This may include, for example, an indication for for a SRS resources transmission power, and/or a SRS sequence resource.

The WTRU may then transmit the CLI indication on the determined UL resource at 612. The CLI indication may include: a WTRU ID or a sequence ID, SRS resource index, or a power offset indication, for example, based on the measured CLI-RSSI or measurement on the DL reception.

The WTRU may determine SRS resources in the SRS resource set based on the mapping between the CLI and SRS resources, and the WTRU may measure the SRS resources and identify which SRS resource contains SRS transmission above a threshold at 614.

The WTRU may report, to the network, the measurement, for example ID associated the SRS transmission resource above the threshold at 616. The measurement value may be compensated for the indicated power offset.

In an embodiment, an aggressor WTRU (WTRU that is the source of CLI) may be (pre)configured with CLI indication resources and a mapping between a CLI event detection and the CLI indication resources. The WTRU may then autonomously trigger the CLI monitoring based on its UL transmission meeting certain criterions, and the WTRU may determines the corresponding resources.

This may allow the WTRU to autonomously determine whether its transmission is likely to generate CLI and monitor for the CLI on predefined resources. In this case, the network doesn't have to control each transmission/monitoring and the WTRU may reduce the overhead/processing.

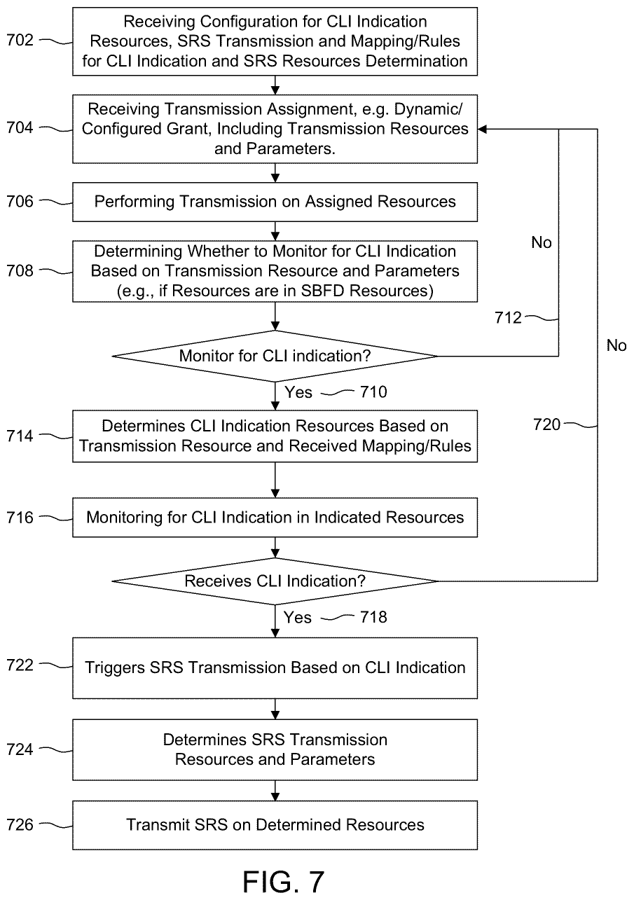

FIG. 7 illustrates a WTRU determining the monitoring of the CLI indication and its resource.

The WTRU may receive a pre-configuration/configuration from the network, for example via RRC at 702. The configuration may include a set of UL resources and format to be monitored after an UL transmission. The monitoring resources may be semi-periodic/periodic resources. The configuration may also include the signal to monitor, for example, a dedicated sequence, an UL RS a PUCCH/PUCCH etc.

The configuration may include a mapping rule between an UL transmission resource and the resources for CLI indication to monitor. The mapping rule may include the time of the CLI indication resource is the earliest resource after the transmission and a delay/offset, and/or comb/frequency/shift/code/sequence may be dependent on time/frequency resource. Also, included in the configuration may be a set of SRS resources for transmission, for example, semi-periodic/periodic resources, and a mapping rule between a CLI indication and a corresponding SRS resource. This mapping rule may include the time of the SRS resource is the earliest resource after the transmission and a delay/offset, and/or a comb/freq/shift/code dependent on TF resource.

The WTRU may receive a configuration for UL transmission, for example semi-periodic/periodic, via MAC/RRC signaling at 704. The WTRU may transmit the UL transmission according to the received UL transmission resources at 706. At 708, WTRU may trigger the monitoring of CLI indication based on one or more of: a position of the UL resources (e.g., if the resources are in a SBFD symbol); transmit power is beyond a (pre)configured threshold; a WTRU position (e.g., if the WTRU is at the cell edge), and/or a transmit beam (e.g., if the used transmit beam is within a configured subset of transmit beams. In a case where the WTRU does not detect a CLI indication, at 712, the WTRU may return to the process at 704 and may receive another transmission assignment and corresponding transmission resources and parameters.

The WTRU may detect the CLI at 710 and at 714, the WTRU may determine the CLI indication resources based on the received mapping between UL transmission resource and CLI indication resources and the resource used for the UL transmission. The WTRU may monitor the resources indicated in a grant assignment/indicated resources at 716. The monitoring may include measuring the energy level on the CLI indication resources and/or measuring the energy power level of the configured sequence and detects that the energy/power is beyond a configured threshold, e.g. based on RSSI, RSRP, SINR, etc. In a case where the WTRU does not receive or detect the CLI indication, at 720 the WTRU may return to the process at 704. In the case where the WTRU receives the CLI indication, at 718, The WTRU may trigger to perform the associated CLI management actions such as transmitting an SRS based on detecting/measuring the CLI indication in the monitored resources at 722.

At 724, the WTRU may determine the SRS resources to use for transmission, for example, based on the configured mapping between the CLI indication and the SRS resources, and SRS transmission parameter (e.g., transmit power and beam). The SRS transmission parameters may include a transmit power and beam that are the same as the UL transmission initiating the CLI indication monitoring. At 726, the WTRU may transmit the SRS using the determined transmission parameters

In an example embodiment, which may be complementary with one or more other embodiments, a WTRU may receive a CLI indication including information about the CLI and expected SRS transmission parameters. The WTRU may trigger an SRS transmission based on the received CLI indication and uses the parameters from the CLI indication, e.g., transmit power, sequence index etc. This may allow the WTRU to coordinate with the victim WTRU to adjust the SRS transmission to its needs for a better CLI detection/identification.

The WTRU may be configured with CLI indication monitoring parameters, for example, CLI indication resources and formats, e.g., based on PUCCH/PUSCH transmissions. The WTRU may perform an UL transmission with a given transmit power and transmit beam, and determine the CLI indication resources associated with the UL transmission.

The WTRU may monitor the CLI indication resources and receive a CLI indication. The CLI indication may trigger a SRS transmission upon receiving a CLI indication in the monitored resources. The CLI indication may include: a request for SRS transmission (e.g., implicitly), a SRS resource and/or sequence indication; an indication of another WTRU's ID; and/or a transmit power indication, for example, a transmit power offset with respect to previous UL transmission.

The WTRU may determine the SRS transmission configurations based on the received CLI indication. For example: the SRS resource may be based on the received resource indication in the CLI indication, and the received mapping; the SRS sequence may be configured to the one received in the CLI indication; the SRS transmit power is the transmit power of the UL transmission initiating the CLI indication monitoring plus the received transmit power offset; and/or the SRS transmission beam is the same as the UL transmission initiating the CLI indication monitoring. The WTRU may transmit the SRS using the determined transmission parameters on the determined/indicated resources.

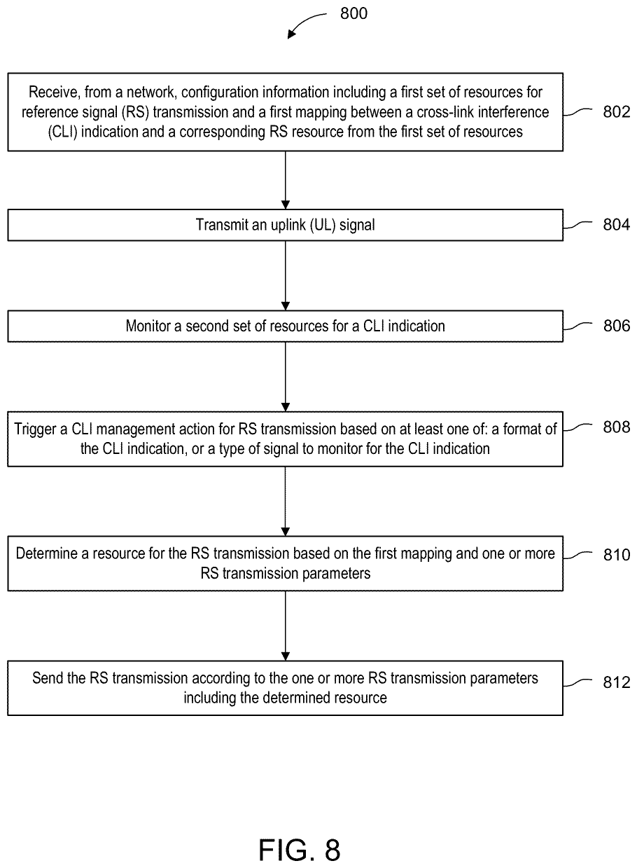

FIG. 8 is a flow diagram of an example CLI management and identification process 800. In some implementations, one or more process blocks of FIG. 8 may be performed by a device. The device may be a WTRU as described above.

As shown in FIG. 8, process 800 may include, at 802, receiving, from a network, configuration information including a first set of resources for reference signal (RS) transmission and a first mapping between a cross-link interference (CLI) indication and a corresponding RS resource from the first set of resources. For example, a WTRU may receive, from a network, configuration information including a first set of resources for reference signal (RS) transmission and a first mapping between a CLI indication and a corresponding RS resource from the first set of resources, as described above. As also shown in FIG. 8, process 800 may include, at 804, transmitting an uplink (UL) signal. For example, the WTRU may transmit an UL signal, as described above. As further shown in FIG. 8, process 800 may include, at 806, monitoring a second set of resources for a CLI indication. For example, the WTRU may monitor a second set of resources for a CLI indication, as described above. As further shown in FIG. 8, process 800 may include, at 808, triggering a CLI management action for RS transmission based on at least one of: a format of the CLI indication, or a type of signal to monitor for the CLI indication. For example, the WTRU may trigger a CLI management action for RS transmission based on at least one of: a format of the CLI indication, or a type of signal to monitor for the CLI indication, as described above. As also shown in FIG. 8, process 800 may include, at 810, determining a resource for the RS transmission based on the first mapping between the CLI indication and the corresponding RS resource, and one or more RS transmission parameters. For example, the WTRU may determine a resource for the RS transmission based on the first mapping between the CLI indication and the corresponding RS resource, and one or more RS transmission parameters, as described above. As further shown in FIG. 8, process 800 may include, at 814, sending the RS transmission according to the one or more RS transmission parameters including the determined resource. For example, the WTRU may send the RS transmission according to the one or more RS transmission parameters including the determined resource, as described above.

Process 800 may include additional implementations, such as any single implementation or any combination of implementations described below and/or in connection with one or more other processes described elsewhere herein. In a first implementation, the RS transmission is at least one of: an UL RS, a sounding reference signal (SRS), an demodulation reference signal (DM-RS), a phase tracking reference signal (PT-RS), a sidelink (SL) synchronization signal block (SSB), a SL-DMRS, or a SL channel state information reference signal (CSI-RS).

In a second implementation, alone or in combination with the first implementation, process 800 further includes receiving, from the network, a second mapping between one or more UL transmission resources and one or more corresponding resources from the second set of resources, wherein the one or more UL transmission resources are configured by the network; and determining the second set of resources based on the second mapping and one or more UL transmission parameters.

In a third implementation, alone or in combination with the first and second implementation, process 800 may include determining to monitor for the CLI indication based on at least one of: transmission parameters of the UL signal transmitted, or a position of the WTRU. In a fourth implementation, alone or in combination with one or more of the first through third implementations, process 800 further includes receiving, from the network, a command to transmit the UL signal, where the command to transmit the UL signal includes an indicator to monitor for the CLI indication on at least one of resource from the second set of resources after transmitting the UL signal.

In a fifth implementation, alone or in combination with one or more of the first through fourth implementations, process 800 may include detecting the CLI indication based on a measurement on CLI indication resources being above a configured threshold value, where the measurement on the CLI indication resources includes at least one of: an energy level, a received signal strength indicator (RSSI) measurement, a reference signal received power (RSRP) measurement, or a signal-to-interference-plus-noise ratio (SINR) measurement.

In a sixth implementation, alone or in combination with one or more of the first through fifth implementations, the type of signal to monitor for the CLI indication is at least one of: a dedicated sequence, or an existing RS, where the existing RS is at least one of: an UL RS, demodulation reference signal (DM-RS), an UL phase tracking reference signal (PT-RS), a sidelink (SL) SSB, a SL RS, or a SL DM-RS.

In a seventh implementation, alone or in combination with one or more of the first through sixth implementations, the one or more RS transmission parameters include at least one of: a transmit power, a transmit beam, or a determined sequence. in an eighth implementation, alone or in combination with one or more of the first through seventh implementations, process 800 may include determining the RS transmission parameters based on the detected CLI indication, where the detected CLI indication includes information indicating at least one of transmit power, or a sequence index.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

What is claimed:

1. A method performed by a wireless transmit/receive unit (WTRU), the method comprising:
receiving, from a network, configuration information including a first set of resources for reference signal (RS) transmission and a first mapping between a cross-link interference (CLI) indication and a corresponding RS resource from the first set of resources;
transmitting an uplink (UL) signal;
monitoring a second set of resources for a CLI indication;
triggering a CLI management action for a RS transmission based on at least one of: a format of the CLI indication, or a type of signal to monitor for the CLI indication;
determining a resource for the RS transmission based on the first mapping and one or more RS transmission parameters; and
sending the RS transmission according to the one or more RS transmission parameters including the determined resource.

2. The method of claim 1, wherein the RS transmission is at least one of: an UL RS, a sounding reference signal (SRS), an demodulation reference signal (DM-RS), a phase tracking reference signal (PT-RS), a sidelink (SL) synchronization signal block (SSB), a SL-DMRS, or a SL channel state information reference signal (CSI-RS).

3. The method of claim 1, further comprising:
receiving, from the network, a second mapping between one or more UL transmission resources and one or more corresponding resources from the second set of resources, wherein the one or more UL transmission resources are configured by the network; and
determining the second set of resources based on the second mapping and one or more UL transmission parameters.

4. The method of claim 3, further comprising determining to monitor for the CLI indication based on at least one of: transmission parameters of the UL signal transmitted, or a position of the WTRU.

5. The method of claim 1, further comprising: receiving, from the network, a command to transmit the UL signal, wherein the command to transmit the UL signal includes an indicator to monitor for the CLI indication on at least one resource from the second set of resources after transmitting the UL signal.

6. The method of claim 5, further comprising detecting the CLI indication based on a measurement on CLI indication resources being above a configured threshold value, wherein the measurement on the CLI indication resources includes at least one of: an energy level, a received signal strength indicator (RSSI) measurement, a reference signal received power (RSRP) measurement, or a signal-to-interference-plus-noise ratio (SINR) measurement.

7. The method of claim 1, wherein the type of signal to monitor for the CLI indication is at least one of: a dedicated sequence, or an existing RS, wherein the existing RS is at least one of: a UL RS, demodulation reference signal (DM-RS), an UL phase tracking reference signal (PT-RS), a sidelink (SL) SSB, a SL RS, or a SL DM-RS.

8. The method of claim 1, wherein the one or more RS transmission parameters include at least one of: a transmit power, a transmit beam, or a determined sequence.

9. The method of claim 1, further comprising determining the RS transmission parameters based on the CLI indication, wherein the CLI indication includes information indicating at least one of transmit power, or a sequence index.

10. A wireless transmit/receive unit (WTRU) comprising:
processor circuitry; and
a transceiver configured to:
receive, from a network, configuration information including a first set of resources for reference signal (RS) transmission and a first mapping between a cross-link interference (CLI) indication and a corresponding RS resource from the first set of resources; and
transmit an uplink (UL) signal;
the processor circuitry configured to:
monitor a second set of resources to detect a CLI indication;
trigger a CLI management action for RS transmission based on at least one of: a format of the CLI indication, or a type of signal to monitor for the CLI indication; and
determine a resource for the RS transmission based on the first mapping between the CLI indication and the corresponding RS resource, and one or more RS transmission parameters; and
the transceiver configured to send the RS transmission according to the one or more RS transmission parameters including the determined resource.

11. The WTRU of claim 10, wherein the RS transmission is at least one of: an UL RS, a sounding reference signal (SRS), an demodulation reference signal (DM-RS), a phase tracking reference signal (PT-RS), a sidelink (SL) synchronization signal block (SSB), a SL-DMRS, or a SL channel state information reference signal (CSI-RS).

12. The WTRU of claim 10, wherein the transceiver is further configured to receive, from the network, a second mapping between one or more UL transmission resources and one or more corresponding resources from the second set of resources, wherein the one or more UL transmission resources are configured by the network; and
wherein the processor circuitry is further configured to determine the second set of resources based on the second mapping and one or more UL transmission parameters.

13. The WTRU of claim 12, wherein the processor circuitry is configured to monitor for the CLI indication based on at least one of: transmission parameters of the UL signal transmitted, or a position of the WTRU.

14. The WTRU of claim 10, wherein the transceiver is further configured to receive, from the network, a command to transmit the UL signal, wherein the command to transmit the UL signal includes an indicator to monitor for the CLI indication on at least one resource from the second set of resources after transmitting the UL signal.

15. The WTRU of claim 14, wherein the processor circuitry is configured to detect the CLI indication based on a measurement on CLI indication resources being above a configured threshold value, wherein the measurement on the CLI indication resources includes at least one of: an energy level, a received signal strength indicator (RSSI) measurement, a reference signal received power (RSRP) measurement, or a signal-to-interference-plus-noise ratio (SINR) measurement.

16. The WTRU of claim 10, wherein the type of signal to monitor for the CLI indication is at least one of: a dedicated sequence, or an existing RS, wherein the existing RS is at least one of: a UL RS, demodulation reference signal (DM-RS), an UL phase tracking reference signal (PT-RS), a sidelink (SL) SSB, a SL RS, or a SL DM-RS.

17. The WTRU of claim 10, the one or more RS transmission parameters include at least one of: a transmit power, a transmit beam, or a determined sequence.

18. The WTRU of claim 10, wherein the processor circuitry is configured to determine the RS transmission parameters based on the CLI indication, wherein the CLI indication includes information indicating at least one of transmit power, or a sequence index.
